(19) United States
(12) Patent Application Publication
(10) Pub. No.: US 2019/0132740 A1
(43) Pub. Date: May 2, 2019

(54) ENHANCED CLOUD INFORMATION SYSTEM WITH PREFETCHING AND CACHING DECISIONS TO FACILITATE DETECTION OF FALSE NETWORK ACCESS NODES

(71) Applicant: QUALCOMM Incorporated, San Diego, CA (US)

(72) Inventors: Subrato Kumar DE, San Diego, CA (US); Mattias Kaulard HUBER, Solana Beach, CA (US); Charles MCGRATH, Bonita, CA (US); Pankaj GARG, San Diego, CA (US); Zaheer AHMAD, San Diego, CA (US)

(21) Appl. No.: 16/004,300

(22) Filed: Jun. 8, 2018

Related U.S. Application Data
(60) Provisional application No. 62/579,850, filed on Oct. 31, 2017.
(60) Provisional application No. 62/582,629, filed on Nov. 7, 2017.

(51) Int. Cl. H04W 12/12; H04L 29/06; H04W 12/08; H04W 12/06

(52) U.S. Cl. CPC H04W 12/12; H04L 63/08; H04W 12/06; H04W 12/08; H04L 63/20

(57) ABSTRACT

In an aspect, a client device in a first network cell may obtain information that indicates a second network cell neighboring the first network cell, wherein the tracking area code (also referred to as location area code) of the second network cell is different from the tracking area code of the first network cell and is not included in the tracking area identifier list of the of the first network cell. The client device may use the obtained information to detect a nearby false network access node that may be imitating the second network access node to lure the client device to connect to the false network access node. In some aspects, a client device in a first geographical location may preemptively obtain a network access node list associated with a second geographical location in order to detect false network access nodes in the second geographical location.

### CLAIM OF PRIORITY UNDER 35 U.S.C. § 119

The present Application for Patent claims priority to U.S. Provisional Application No. 62/579,850 entitled “DYNAMIC ADJUSTMENT AND VARIABLE POINTS BASED ALGORITHM USING CONTEXTUAL INFORMATION FOR DETECTING FALSE NETWORK ACCESS NODES IN LTE AND UMTS NETWORKS” filed Oct. 31, 2017, and to U.S. Provisional Application No. 62/582,629 entitled “ENHANCED CLOUD INFORMATION SYSTEM WITH PREFETCHING AND CACHING DECISIONS TO FACILITATE DETECTION OF FALSE NETWORK ACCESS NODES” filed Nov. 7, 2017, which are assigned to the assignee hereof and hereby expressly incorporated by reference herein.

### INTRODUCTION

### Field of the Disclosure

Aspects of the disclosure relate generally to a method and apparatus for client device side detection of false network access nodes in communication networks. an enhanced cloud information system with prefetching and caching decisions to facilitate detection of false network access nodes.

### Background

Attackers may deploy false network access nodes in mobile communication networks to make unauthorized connections to client devices (e.g., user equipments (UEs), such as smartphones). Such connections may result in theft of valuable information from users, destruction/corruption of data, loss of privacy, and/or unauthorized control of client devices. Conventional approaches implemented by client devices for detecting and ceasing communications with such false network access nodes raise false positives and are not adequate in many scenarios.

### SUMMARY

The following presents a simplified summary of some aspects of the disclosure to provide a basic understanding of such aspects. This summary is not an extensive overview of all contemplated features of the disclosure and is intended neither to identify key or critical elements of all aspects of the disclosure nor to delineate the scope of any or all aspects of the disclosure. Its sole purpose is to present various concepts of some aspects of the disclosure in a simplified form as a prelude to the more detailed description that is presented later.

In an aspect of the disclosure, a method is provided. The method may be performed by a client device as described herein. The client device may obtain, in a first network cell, information from a network access node list (also referred to as a geographical whitelist database of authentic network access nodes), the information indicating a tracking area identifier of a second network cell neighboring the first network cell, wherein the tracking area identifier of the second network cell is different from a tracking area identifier of the first network cell. The client device may detect that a network access node of a third network cell (e.g., a network access node advertising itself to the client device as being available for connection) is a false network access node based on at least the tracking area identifier of the second network cell, wherein at least a portion of the third network cell is included in at least one of the first network cell or the second network cell. The client device may refrain from connecting to the network access node of the third network cell and/or cease communication with the network access node of the third network cell in response to the detection. For example, the client device may cease communication with the network access node of the third network in response to the detection in scenarios where the client device has already connected to the third network cell. In some aspects of the disclosure, the client device may obtain a blacklist of known or suspected false network access nodes. In such aspects, the detecting that the network access node of the third network cell is a false network access node may be further based on the network access node of the third network cell being included in the blacklist of known or suspected false network access nodes. In some aspects of the disclosure, the client device may alert at least an application layer or an operating system of the client device about a potential threat in a network environment of the client device upon the detection. In some aspects of the disclosure, the client device may initiate communication with a different communication network. In some aspects of the disclosure, the client device may transmit a risk score associated with the network access node of the third network cell after the detection. In some aspects of the disclosure, the client device may detect one or more frequencies of the network access node of the third network cell.

In an aspect of the disclosure, a method is provided. The method may be performed by a client device as described herein. The client device may obtain, in a first network cell, information from a network access node list (also referred to as a geographical whitelist database of authentic network access nodes), the information indicating a tracking area identifier of a second network cell neighboring the first network cell, wherein the tracking area identifier of the second network cell is different from a tracking area identifier of the first network cell. The client device may detect that a network access node in or near the second network cell is a false network access node based on at least the information from the network access node list. The client device may cease communication with the network access node in or near the second network cell upon the detection. In some aspects of the disclosure, the client device may alert at least an application layer or an operating system of the client device about a potential threat in a network environment of the client device upon the detection. In some aspects of the disclosure, the client device may initiate communication with a different communication network. In some aspects of the disclosure, the client device may transmit a risk score associated with the network access node in or near the second network cell after the detection.

In an aspect of the disclosure, a method is provided. The method may be performed by a client device as described herein. The client device may obtain, in a first geographical location, at least one portion of a network access node list associated with a second geographical location, wherein the second geographical location is an intended destination of the client device, store the at least one portion of the network access node list in a memory of the client device, disable a transceiver of the client device after the at least one portion of the network access node list has been stored, enable the transceiver of the client device at the second geographical location, and detect that a network access node in the second geographical location is a false network access node based on the at least one portion of the network access node list.

In an aspect of the disclosure, a method is provided. The method may be performed by a client device as described herein. The client device may obtain future availability information from a network access node list, the future availability information including at least an indication that a network access node operates intermittently, a periodic ON/OFF switching pattern of the network access node, aperiodic ON/OFF future time values listed as a vector of time values for the network access node, or one or more future time periods during which the network access node will be operating, wherein the availability information is based on information gathered from at least a public information system, a publicly available source, or a website. The client device may communicate with the network access node based on the future availability information from the network access node list. In some aspects of the disclosure, a location of the network access node is fixed, and the information gathered from at least a public information system, a publicly available source, or a website includes a venue and a time of a scheduled event, wherein the location of the network access node is proximate to the venue of the scheduled event. In some aspects of the disclosure, the network access node is a femto network access node or a pico network access node.

In an aspect of the disclosure, a method is provided. The method may be performed by a network device as described herein. The network device may obtain first availability information for at least one network access node from at least a public information system, a publicly available source, or a website, the first availability information including at least an indication that the at least one network access node operates intermittently, a periodic ON/OFF pattern of the at least one network access node, or one or more future time periods during which the at least one network access node will be operating. The network device may store the first availability information in an entry in a network access node list, wherein the entry corresponds to the at least one network access node, and transmit at least one portion of the network access node list to a client device, the at least one portion including the first availability information. In some aspects of the disclosure, the network device may discard second availability information stored in the entry in the network access node list when the second availability information corresponds to a time period that has already passed. In some aspects of the disclosure, a location of the at least one network access node is fixed. In such aspects of the disclosure, the network device may obtain the availability information by obtaining a venue and a time of a scheduled event from at least the public information system, the publicly available source, or the website, and determining that the location of the at least one network access node is proximate to the venue, wherein the availability information is based on at least the venue or the time of the scheduled event.

In an aspect of the disclosure, a method is provided. The method may be performed by a network device as described herein. The network device may obtain network cell transition information from one or more client devices, the network cell transition information indicating that a tracking area identifier change has been detected by the one or more client devices when leaving a first network cell and entering a second network cell, wherein the first network cell neighbors the second network cell. The network device may store the network cell transition information in an entry in a network access node list, wherein the entry corresponds to the first network cell or a network access node that supports the first network cell, and transmit at least one portion of the network access node list to a client device, the at least one portion including the network cell transition information. In some aspects of the disclosure, the network device may obtain a direction of the second network cell relative to the first network cell and store the direction in the entry in the network access node list. In some aspects of the disclosure, the network device may obtain a plurality of risk scores for at least the second network cell from the plurality of client devices, consolidate the plurality of risk scores into a single risk score, store the single risk score in the entry in the network access node list, and transmit the single risk score to the client device. In some aspects of the disclosure, the network cell transition information includes at least one tracking area identifier that is different from a tracking area identifier of the first network cell.

In an aspect of the disclosure, a method is provided. The method may be performed by a network device as described herein. The network device may obtain information from one or more client devices, wherein the information includes at least a notification that a mutual authentication procedure with a network access node has failed, a risk score indicating a probability that the network access node is a false network access node, one or more frequencies an operator has used for the network access node, or one or more tracking area codes assigned to the network access node at different time periods, store at least the information or one or more values based on the information in an entry of a network access node list, wherein the entry corresponds to the network access node, and transmit at least one portion of the network access node list to at least one client device. In an aspect of the disclosure, the network device may determine that the network access node uses the one or more tracking area codes at the different time periods based on the information. In such aspect, the one or more values includes a tracking area code flag configured to indicate that a tracking area code of the network access node changes in a periodic and/or predictable manner. In an aspect of the disclosure, the network device may determine one or more time durations and corresponding tracking area codes for the network access node based on the information. In such aspect, the one or more values includes the one or more time durations and the corresponding tracking area codes. In some aspects of the disclosure, the one or more time durations are portions of a repeatable period. In some aspects of the disclosure, the at least one client device is one of the one or more client devices. In some aspects of the disclosure, the at least one client device is not one of the one or more client devices. In some aspects of the disclosure, the information or the one or more values is stored when the one or more client devices from which the information is obtained has successfully performed the mutual authentication procedure with at least one network access node.

In an aspect of the disclosure, an apparatus is provided. The apparatus may be a client device as described herein. The apparatus may include a processing circuit configured to obtain, in a first network cell, information from a network access node list (also referred to as a geographical whitelist database of authentic network access nodes), the information indicating a tracking area identifier of a second network cell neighboring the first network cell, wherein the tracking area identifier of the second network cell is different from a tracking area identifier of the first network cell. The processing circuit may be further configured to detect that a network access node of a third network cell (e.g., a network access node advertising itself to the client device as being available for connection) is a false network access node based on at least the tracking area identifier of the second network cell, wherein at least a portion of the third network cell is included in at least one of the first network cell or the second network cell. The processing circuit may be further configured to refrain from connecting to the network access node of the third network cell and/or cease communication with the network access node of the third network cell in response to the detection. In some aspects of the disclosure, the processing circuit may be further configured to obtain a blacklist of known or suspected false network access nodes. In such aspects, the detection that the network access node of the third network cell is a false network access node may be further based on the network access node of the third network cell being included in the blacklist of known or suspected false network access nodes. In some aspects of the disclosure, the processing circuit may be further configured to alert at least an application layer or an operating system of the client device about a potential threat in a network environment of the client device upon the detection. In some aspects of the disclosure, the processing circuit may be further configured to initiate communication with a different communication network. In some aspects of the disclosure, the processing circuit may be further configured to transmit a risk score associated with the network access node of the third network cell after the detection. In some aspects of the disclosure, the processing circuit may be further configured to detect one or more frequencies of the network access node of the third network cell.

In an aspect of the disclosure, an apparatus is provided. The apparatus may be a client device as described herein. The apparatus may include a processing circuit configured to obtain, in a first network cell, information from a network access node list (also referred to as a geographical whitelist database of authentic network access nodes), the information indicating a tracking area identifier of a second network cell neighboring the first network cell, wherein the tracking area identifier of the second network cell is different from a tracking area identifier of the first network cell. The processing circuit may be further configured to detect that a network access node in or near the second network cell is a false network access node based on at least the information from the network access node list. The processing circuit may be further configured to cease communication with the network access node in or near the second network cell upon the detection. In some aspects of the disclosure, the processing circuit may be further configured to alert at least an application layer or an operating system of the client device about a potential threat in a network environment of the client device upon the detection. In some aspects of the disclosure, the processing circuit may be further configured to initiate communication with a different communication network. In some aspects of the disclosure, the processing circuit may be further configured to transmit a risk score associated with the network access node in or near the second network cell after the detection.

In an aspect of the disclosure, an apparatus is provided. The apparatus may be a client device as described herein. The apparatus may include a processing circuit configured to obtain, at a client device in a first geographical location, at least one portion of a network access node list associated with a second geographical location, wherein the second geographical location is an intended destination of the client device. The processing circuit may be further configured to store the at least one portion of the network access node list in a memory of the client device, disable a transceiver of the client device after the at least one portion of the network access node list has been stored, enable the transceiver of the client device at the second geographical location, and detect that a network access node in the second geographical location is a false network access node based on the at least one portion of the network access node list.

In an aspect of the disclosure, an apparatus is provided. The apparatus may be a client device as described herein. The apparatus may include a processing circuit configured to obtain future availability information from a network access node list, the future availability information including at least an indication that a network access node operates intermittently, a periodic ON/OFF switching pattern of the network access node, aperiodic ON/OFF future time values listed as a vector of time values for the network access node, or one or more future time periods during which the network access node will be operating, wherein the availability information is based on information gathered from at least a public information system, a publicly available source, or a website. The processing circuit may be further configured to communicate with the network access node based on the future availability information from the network access node list.

In an aspect of the disclosure, an apparatus is provided. The apparatus may be a network device as described herein. The apparatus may include a processing circuit configured to obtain first availability information for at least one network access node from at least a public information system, a publicly available source, or a website, the first availability information including at least an indication that the at least one network access node operates intermittently, a periodic ON/OFF pattern of the at least one network access node, or one or more future time periods during which the at least one network access node will be operating. The processing circuit may be further configured to store the first availability information in an entry in a network access node list, wherein the entry corresponds to the at least one network access node, and transmit at least one portion of the network access node list to a client device, the at least one portion including the first availability information.

In an aspect of the disclosure, an apparatus is provided. The apparatus may be a network device as described herein. The apparatus may include a processing circuit configured to obtain network cell transition information from one or more client devices, the network cell transition information indicating that a tracking area identifier change has been detected by the one or more client devices when leaving a first network cell and entering a second network cell, wherein the first network cell neighbors the second network cell. The processing circuit may be further configured to store the network cell transition information in an entry in a network access node list, wherein the entry corresponds to the first network cell or a network access node that supports the first network cell, and transmit at least one portion of the network access node list to a client device, the at least one portion including the network cell transition information.

In an aspect of the disclosure, an apparatus is provided. The apparatus may be a network device as described herein. The apparatus may include a processing circuit configured to obtain information from one or more client devices, wherein the information includes at least a notification that a mutual authentication procedure with a network access node has failed, a risk score indicating a probability that the network access node is a false network access node, one or more frequencies an operator has used for the network access node, or one or more tracking area codes assigned to the network access node at different time periods, store at least the information or one or more values based on the information in an entry of a network access node list, wherein the entry corresponds to the network access node, and transmit at least one portion of the network access node list to at least one client device. In an aspect of the disclosure, the processing circuit may be configured to determine that the network access node uses the one or more tracking area codes at the different time periods based on the information. In such aspect, the one or more values includes a tracking area code flag configured to indicate that a tracking area code of the network access node changes in a periodic and/or predictable manner In an aspect of the disclosure, processing circuit may be configured to determine one or more time durations and corresponding tracking area codes for the network access node based on the information. In such aspect, the one or more values includes the one or more time durations and the corresponding tracking area codes. In some aspects of the disclosure, the one or more time durations are portions of a repeatable period. In some aspects of the disclosure, the information or the one or more values is stored when the one or more client devices from which the information is obtained has successfully performed the mutual authentication procedure with at least one network access node.

In an aspect of the disclosure, an apparatus is provided. The apparatus may be a client device as described herein. The apparatus may include means for obtaining, in a first network cell, information from a network access node list (also referred to as a geographical whitelist database of authentic network access nodes), the information indicating a tracking area identifier of a second network cell neighboring the first network cell, wherein the tracking area identifier of the second network cell is different from a tracking area identifier of the first network cell. The apparatus may further include means for detecting that a network access node of a third network cell (e.g., a network access node advertising itself to the client device as being available for connection) is a false network access node based on at least the tracking area identifier of the second network cell, wherein at least a portion of the third network cell is included in at least one of the first network cell or the second network cell. The apparatus may further include means for refraining from connecting to the network access node of the third network cell and/or ceasing communication with the network access node of the third network cell in response to the detection. In some aspects of the disclosure, the apparatus may further include means for obtaining a blacklist of known or suspected false network access nodes. In such aspects, the detection that the network access node of the third network cell is a false network access node may be further based on the network access node of the third network cell being included in the blacklist of known or suspected false network access nodes. In some aspects of the disclosure, the apparatus may further include means for alerting at least an application layer or an operating system of the apparatus about a potential threat in a network environment of the apparatus upon the detection. In some aspects of the disclosure, the apparatus may further include means for initiating communication with a different communication network. In some aspects of the disclosure, the apparatus may further include means for transmitting a risk score associated with the network access node of the third network cell after the detection. In some aspects of the disclosure, the apparatus may detect one or more frequencies of the network access node of the third network cell.

In an aspect of the disclosure, an apparatus is provided. The apparatus may be a client device as described herein. The apparatus may include means for obtaining, in a first network cell, information from a network access node list (also referred to as a geographical whitelist database of authentic network access nodes), the information indicating a tracking area identifier of a second network cell neighboring the first network cell, wherein the tracking area identifier of the second network cell is different from a tracking area identifier of the first network cell. The apparatus may further include means for detecting that a network access node in or near the second network cell is a false network access node based on at least the information from the network access node list. The apparatus may further include means for ceasing communication with the network access node in or near the second network cell upon the detection. In some aspects of the disclosure, the apparatus may further include means for alerting at least an application layer or an operating system of the apparatus about a potential threat in a network environment of the apparatus upon the detection. In some aspects of the disclosure, the apparatus may further include means for initiating communication with a different communication network. In some aspects of the disclosure, the apparatus may further include means for transmitting a risk score associated with the network access node in or near the second network cell after the detection.

In an aspect of the disclosure, an apparatus is provided. The apparatus may be a client device as described herein. The apparatus may include means for obtaining, at a client device in a first geographical location, at least one portion of a network access node list associated with a second geographical location, wherein the second geographical location is an intended destination of the client device, means for storing the at least one portion of the network access node list in a memory of the client device, means for disabling a transceiver of the client device after the at least one portion of the network access node list has been stored, means for enabling the transceiver of the client device at the second geographical location, and means for detecting that a network access node in the second geographical location is a false network access node based on the at least one portion of the network access node list.

In an aspect of the disclosure, an apparatus is provided. The apparatus may be a client device as described herein. The apparatus may include means for obtaining future availability information from a network access node list, the future availability information including at least an indication that a network access node operates intermittently, a periodic ON/OFF switching pattern of the network access node, aperiodic ON/OFF future time values listed as a vector of time values for the network access node, or one or more future time periods during which the network access node will be operating, wherein the availability information is based on information gathered from at least a public information system, a publicly available source, or a website. The apparatus may further include means for communicating with the network access node based on the future availability information from the network access node list.

In an aspect of the disclosure, an apparatus is provided. The apparatus may be a network device as described herein. The apparatus may include means for obtaining first availability information for at least one network access node from at least a public information system, a publicly available source, or a website, the first availability information including at least an indication that the at least one network access node operates intermittently, a periodic ON/OFF pattern of the at least one network access node, or one or more future time periods during which the at least one network access node will be operating. The apparatus may further include means for storing the first availability information in an entry in a network access node list, wherein the entry corresponds to the at least one network access node, and means for transmitting at least one portion of the network access node list to a client device, the at least one portion including the first availability information.

In an aspect of the disclosure, an apparatus is provided. The apparatus may be a network device as described herein. The apparatus may include means for obtaining network cell transition information from one or more client devices, the network cell transition information indicating that a tracking area identifier change has been detected by the one or more client devices when leaving a first network cell and entering a second network cell, wherein the first network cell neighbors the second network cell, means for storing the network cell transition information in an entry in a network access node list, wherein the entry corresponds to the first network cell or a network access node that supports the first network cell, and means for transmitting at least one portion of the network access node list to a client device, the at least one portion including the network cell transition information.

In an aspect of the disclosure, an apparatus is provided. The apparatus may be a network device as described herein. The apparatus may include means for obtaining information from one or more client devices, wherein the information includes at least a notification that a mutual authentication procedure with a network access node has failed, a risk score indicating a probability that the network access node is a false network access node, one or more frequencies an operator has used for the network access node, or one or more tracking area codes assigned to the network access node at different time periods, means for storing at least the information or one or more values based on the information in an entry of a network access node list, wherein the entry corresponds to the network access node, and means for transmitting at least one portion of the network access node list to at least one client device. In an aspect of the disclosure, the network device may further include means for determining that the network access node uses the one or more tracking area codes at the different time periods based on the information. In such aspect, the one or more values includes a tracking area code flag configured to indicate that a tracking area code of the network access node changes in a periodic and/or predictable manner. In an aspect of the disclosure, the network device may further include means for determining one or more time durations and corresponding tracking area codes for the network access node based on the information. In such aspect, the one or more values includes the one or more time durations and the corresponding tracking area codes. In some aspects of the disclosure, the one or more time durations are portions of a repeatable period. In some aspects of the disclosure, the at least one client device is one of the one or more client devices. In some aspects of the disclosure, the at least one client device is not one of the one or more client devices. In some aspects of the disclosure, the information or the one or more values is stored when the one or more client devices from which the information is obtained has successfully performed the mutual authentication procedure with at least one network access node.

In an aspect of the disclosure, a non-transitory machine-readable storage medium is provided. The machine-readable storage medium may have one or more instructions which when executed by a processing circuit causes the processing circuit to obtain, in a first network cell, information from a network access node list (also referred to as a geographical whitelist database of authentic network access nodes), the information indicating a tracking area identifier of a second network cell neighboring the first network cell, wherein the tracking area identifier of the second network cell is different from a tracking area identifier of the first network cell. The one or more instructions may further cause the processing circuit to detect that a network access node of a third network cell (e.g., a network access node advertising itself to the client device as being available for connection) is a false network access node based on at least the tracking area identifier of the second network cell, wherein at least a portion of the third network cell is included in at least one of the first network cell or the second network cell. The one or more instructions may further cause the processing circuit to refrain from connecting to the network access node of the third network cell and/or cease communication with the network access node of the third network cell in response to the detection.

In an aspect of the disclosure, a non-transitory machine-readable storage medium is provided. The machine-readable storage medium may have one or more instructions which when executed by a processing circuit causes the processing circuit to obtain, in a first network cell, information from a network access node list (also referred to as a geographical whitelist database of authentic network access nodes), the information indicating a tracking area identifier of a second network cell neighboring the first network cell, wherein the tracking area identifier of the second network cell is different from a tracking area identifier of the first network cell. The one or more instructions may further cause the processing circuit to detect that a network access node in or near the second network cell is a false network access node based on at least the information from the network access node list. The one or more instructions may further cause the processing circuit to cease communication with the network access node in or near the second network cell upon the detection.

In an aspect of the disclosure, a non-transitory machine-readable storage medium is provided. The machine-readable storage medium may have one or more instructions which when executed by a processing circuit causes the processing circuit to obtain, at a client device in a first geographical location, at least one portion of a network access node list associated with a second geographical location, wherein the second geographical location is an intended destination of the client device, store the at least one portion of the network access node list in a memory of the client device, disable a transceiver of the client device after the at least one portion of the network access node list has been stored, enable the transceiver of the client device at the second geographical location, and detect that a network access node in the second geographical location is a false network access node based on the at least one portion of the network access node list.

In an aspect of the disclosure, a non-transitory machine-readable storage medium is provided. The machine-readable storage medium may have one or more instructions which when executed by a processing circuit causes the processing circuit to obtain future availability information from a network access node list, the future availability information including at least an indication that a network access node operates intermittently, a periodic ON/OFF switching pattern of the network access node, aperiodic ON/OFF future time values listed as a vector of time values for the network access node, or one or more future time periods during which the network access node will be operating, wherein the availability information is based on information gathered from at least a public information system, a publicly available source, or a website, and communicate with the network access node based on the future availability information from the network access node list.

In an aspect of the disclosure, a non-transitory machine-readable storage medium is provided. The machine-readable storage medium may have one or more instructions which when executed by a processing circuit causes the processing circuit to obtain first availability information for at least one network access node from at least a public information system, a publicly available source, or a website, the first availability information including at least an indication that the at least one network access node operates intermittently, a periodic ON/OFF pattern of the at least one network access node, or one or more future time periods during which the at least one network access node will be operating, store the first availability information in an entry in a network access node list, wherein the entry corresponds to the at least one network access node, and transmit at least one portion of the network access node list to a client device, the at least one portion including the first availability information.

In an aspect of the disclosure, a non-transitory machine-readable storage medium is provided. The machine-readable storage medium may have one or more instructions which when executed by a processing circuit causes the processing circuit to obtain network cell transition information from one or more client devices, the network cell transition information indicating that a tracking area identifier change has been detected by the one or more client devices when leaving a first network cell and entering a second network cell, wherein the first network cell neighbors the second network cell, store the network cell transition information in an entry in a network access node list, wherein the entry corresponds to the first network cell or a network access node that supports the first network cell, and transmit at least one portion of the network access node list to a client device, the at least one portion including the network cell transition information.

In an aspect of the disclosure, a non-transitory machine-readable storage medium is provided. The machine-readable storage medium may have one or more instructions which when executed by a processing circuit causes the processing circuit to obtain information from one or more client devices, wherein the information includes at least a notification that a mutual authentication procedure with a network access node has failed, a risk score indicating a probability that the network access node is a false network access node, one or more frequencies an operator has used for the network access node, or one or more tracking area codes assigned to the network access node at different time periods, store at least the information or one or more values based on the information in an entry of a network access node list, wherein the entry corresponds to the network access node, and transmit at least one portion of the network access node list to at least one client device. In an aspect of the disclosure, In some aspects, the one or more instructions which when executed by the processing circuit further causes the processing circuit to determine that the network access node uses the one or more tracking area codes at the different time periods based on the information. In such aspect, the one or more values includes a tracking area code flag configured to indicate that a tracking area code of the network access node changes in a periodic and/or predictable manner In some aspects, the one or more instructions which when executed by the processing circuit further causes the processing circuit to determine one or more time durations and corresponding tracking area codes for the network access node based on the information. In such aspect, the one or more values includes the one or more time durations and the corresponding tracking area codes. In some aspects of the disclosure, the one or more time durations are portions of a repeatable period. In some aspects of the disclosure, the at least one client device is one of the one or more client devices. In some aspects of the disclosure, the at least one client device is not one of the one or more client devices. In some aspects of the disclosure, the information or the one or more values is stored when the one or more client devices from which the information is obtained has successfully performed the mutual authentication procedure with at least one network access node.

These and other aspects of the disclosure will become more fully understood upon a review of the detailed description, which follows. Other aspects, features, and implementations of the disclosure will become apparent to those of ordinary skill in the art, upon reviewing the following description of specific implementations of the disclosure in conjunction with the accompanying figures. While features of the disclosure may be discussed relative to certain implementations and figures below, all implementations of the disclosure can include one or more of the advantageous features discussed herein. In other words, while one or more implementations may be discussed as having certain advantageous features, one or more of such features may also be used in accordance with the various implementations of the disclosure discussed herein. In similar fashion, while certain implementations may be discussed below as device, system, or method implementations it should be understood that such implementations can be implemented in various devices, systems, and methods.

### BRIEF DESCRIPTION OF THE DRAWINGS

FIG. 1 is a conceptual diagram illustrating an example of a radio access network.

FIG. 2 is a block diagram conceptually illustrating an example of a network access node communicating with one or more client devices according to some embodiments.

FIG. 3 is a block diagram conceptually illustrating an example of a hardware implementation for a client device according to some aspects of the disclosure.

FIG. 4 is a block diagram conceptually illustrating an example of a hardware implementation for a network device according to some aspects of the disclosure.

FIG. 5 illustrates an example network configuration showing a man-in-the-middle attack.

FIG. 6 illustrates an example network configuration showing a client device under attack by a false network access node.

FIG. 7 illustrates an example attach procedure for a client device in a communication network that includes at least a network access node and a mobility management entity (MME).

FIG. 8 illustrates an example configuration of a mobile communication network.

FIG. 9A illustrates an example geographical whitelist database of network access nodes in accordance with some aspects of the disclosure.

FIG. 9B illustrates an example geographical whitelist database of network access nodes and an example blacklist of false network access nodes in accordance with some aspects of the disclosure.

FIG. 10 illustrates an example network configuration for obtaining information for a geographical whitelist database of network access nodes in accordance with various aspects of the disclosure.

FIG. 11 (including FIGS. 11A and 11B) is a flow chart illustrating an exemplary process according to some aspects of the disclosure.

FIG. 12 is a flow chart illustrating an exemplary process according to some aspects of the disclosure.

FIG. 13 is a flow chart illustrating an exemplary process according to some aspects of the disclosure.

FIG. 14 is a flow chart illustrating an exemplary process according to some aspects of the disclosure.

FIG. 15 is a flow chart illustrating an exemplary process according to some aspects of the disclosure.

FIG. 16 is a flow chart illustrating an exemplary process according to some aspects of the disclosure.

FIG. 17 (including FIGS. 17A and 17B) is a flow chart illustrating an exemplary process according to some aspects of the disclosure.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

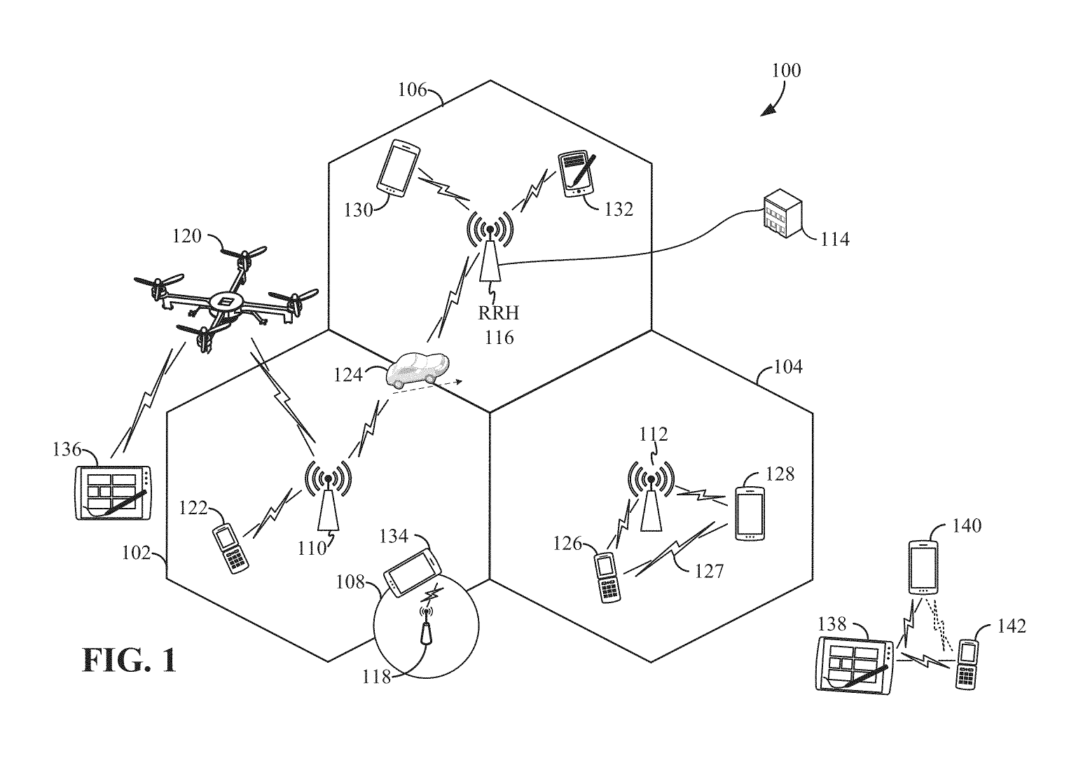

The various concepts presented throughout this disclosure may be implemented across a broad variety of telecommunication systems, network architectures, and communication standards. Referring now to FIG. 1, as an illustrative example without limitation, a schematic illustration of a radio access network 100 is provided.

The geographic region covered by the radio access network 100 may be divided into a number of cellular regions (cells) that can be uniquely identified by a client device based on an identification broadcasted over a geographical area from one access point or network access node. FIG. 1 illustrates macrocells 102, 104, and 106, and a small cell 108, each of which may include one or more sectors. A sector is a sub-area of a cell. All sectors within one cell are served by the same network access node. A radio link within a sector can be identified by a single logical identification belonging to that sector. In a cell that is divided into sectors, the multiple sectors within a cell can be formed by groups of antennas with each antenna responsible for communication with client devices in a portion of the cell.

In general, a network access node serves each cell. Broadly, a network access node is a network element in a radio access network responsible for radio transmission and reception in one or more cells to or from a client device. A network access node may also be referred to by those skilled in the art as a base station (BS), base transceiver station (BTS), a radio base station, a radio transceiver, a transceiver function, a basic service set (BSS), an extended service set (ESS), an access point (AP), a Node B (NB), an eNode B (eNB), a gNode B (gNB), or some other suitable terminology.

In FIG. 1, two high-power network access nodes 110 and 112 are shown in cells 102 and 104; and a third high-power network access node 114 is shown controlling a remote radio head (RRH) 116 in cell 106. That is, a network access node can have an integrated antenna or can be connected to an antenna or RRH by feeder cables. In the illustrated example, the cells 102, 104, and 106 may be referred to as macrocells, as the high-power network access nodes 110, 112, and 114 support cells having a large size. Further, a low-power network access node 118 is shown in the small cell 108 (e.g., a microcell, picocell, femtocell, home network access node, home Node B, home eNode B, etc.) which may overlap with one or more macrocells. In this example, the cell 108 may be referred to as a small cell, as the low-power network access node 118 supports a cell having a relatively small size. Cell sizing can be done according to system design as well as component constraints. It is to be understood that the radio access network 100 may include any number of wireless network access nodes and cells. Further, a relay node may be deployed to extend the size or coverage area of a given cell. The network access nodes 110, 112, 114, 118 provide wireless access points to a core network for any number of mobile apparatuses.

FIG. 1 further includes a quadcopter or drone 120, which may be configured to function as a network access node. That is, in some examples, a cell may not necessarily be stationary, and the geographic area of the cell may move according to the location of a mobile network access node such as the quadcopter 120.

In general, network access nodes may include a backhaul interface for communication with a backhaul portion of the network. The backhaul may provide a link between a network access node and a core network, and in some examples, the backhaul may provide interconnection between the respective network access nodes. The core network is a part of a wireless communication system that is generally independent of the radio access technology used in the radio access network. Various types of backhaul interfaces may be employed, such as a direct physical connection, a virtual network, or the like using any suitable transport network. Some network access nodes may be configured as integrated access and backhaul (IAB) nodes, where the wireless spectrum may be used both for access links (i.e., wireless links with client devices), and for backhaul links This scheme is sometimes referred to as wireless self-backhauling. By using wireless self-backhauling, rather than requiring each new network access node deployment to be outfitted with its own hard-wired backhaul connection, the wireless spectrum utilized for communication between the network access node and client device may be leveraged for backhaul communication, enabling fast and easy deployment of highly dense small cell networks.

The radio access network 100 is illustrated supporting wireless communication for multiple mobile apparatuses (also referred to as client devices). A mobile apparatus is commonly referred to as user equipment (UE) in standards and specifications promulgated by the 3rd Generation Partnership Project (3GPP), but may also be referred to by those skilled in the art as a mobile station (MS), a subscriber station, a mobile unit, a subscriber unit, a wireless unit, a remote unit, a mobile device, a wireless device, a wireless communications device, a remote device, a mobile subscriber station, an access terminal (AT), a mobile terminal, a wireless terminal, a remote terminal, a handset, a terminal, a user agent, a mobile client, a client, or some other suitable terminology. A client device may be an apparatus that provides a user with access to network services.

Within the present document, a “mobile” apparatus need not necessarily have a capability to move, and may be stationary. The term mobile apparatus or mobile device broadly refers to a diverse array of devices and technologies. For example, some non-limiting examples of a mobile apparatus include a mobile, a cellular (cell) phone, a smart phone, a session initiation protocol (SIP) phone, a laptop, a personal computer (PC), a notebook, a netbook, a smartbook, a tablet, a personal digital assistant (PDA), and a broad array of embedded systems, e.g., corresponding to an “Internet of things” (IoT). A mobile apparatus may additionally be an automotive or other transportation vehicle, a remote sensor or actuator, a robot or robotics device, a satellite radio, a global positioning system (GPS) device, an object tracking device, a drone, a multi-copter, a quad-copter, a remote control device, a consumer and/or wearable device, such as eyewear, a wearable camera, a virtual reality device, a smart watch, a health or fitness tracker, a digital audio player (e.g., MP3 player), a camera, a game console, etc. A mobile apparatus may additionally be a digital home or smart home device such as a home audio, video, and/or multimedia device, an appliance, a vending machine, intelligent lighting, a home security system, a smart meter, etc. A mobile apparatus may additionally be a smart energy device, a security device, a solar panel or solar array, a municipal infrastructure device controlling electric power (e.g., a smart grid), lighting, water, etc.; an industrial automation and enterprise device; a logistics controller; agricultural equipment; military defense equipment, vehicles, aircraft, ships, and weaponry, etc. Still further, a mobile apparatus may provide for connected medicine or telemedicine support, i.e., health care at a distance. Telehealth devices may include telehealth monitoring devices and telehealth administration devices, whose communication may be given preferential treatment or prioritized access over other types of information, e.g., in terms of prioritized access for transport of critical service data, and/or relevant QoS for transport of critical service data.

Within the radio access network 100, the cells may include client devices that may be in communication with one or more sectors of each cell. For example, client devices 122 and 124 may be in communication with network access node 110; client devices 126 and 128 may be in communication with network access node 112; client devices 130 and 132 may be in communication with network access node 114 by way of RRH 116; client device 134 may be in communication with low-power network access node 118; and client device 136 may be in communication with mobile network access node 120. Here, each network access node 110, 112, 114, 118, and 120 may be configured to provide an access point to a core network (not shown) for all the client devices in the respective cells. Transmissions from a network access node (e.g., network access node 110) to one or more client devices (e.g., client devices 122 and 124) may be referred to as downlink (DL) transmission, while transmissions from a client device (e.g., client device 122) to a network access node may be referred to as uplink (UL) transmissions. In accordance with certain aspects of the present disclosure, the term downlink may refer to a point-to-multipoint transmission originating at a network access node 202. Another way to describe this scheme may be to use the term broadcast channel multiplexing. In accordance with further aspects of the present disclosure, the term uplink may refer to a point-to-point transmission originating at a client device 204.

In some examples, a mobile network node (e.g., quadcopter 120) may be configured to function as a client device. For example, the quadcopter 120 may operate within cell 102 by communicating with network access node 110. In some aspects of the disclosure, two or more client devices (e.g., client devices 126 and 128) may communicate with each other using peer to peer (P2P) or sidelink signals 127 without relaying that communication through a network access node (e.g., network access node 112).

In the radio access network 100, the ability for a client device to communicate while moving, independent of its location, is referred to as mobility. The various physical channels between the client device and the radio access network are generally set up, maintained, and released under the control of an access and mobility management function (AMF), which may include a security context management function (SCMF) that manages the security context for both the control plane and the user plane functionality, and a security anchor function (SEAF) that performs authentication. In various aspects of the disclosure, a radio access network 100 may utilize DL-based mobility or UL-based mobility to enable mobility and handovers (i.e., the transfer of a client device's connection from one radio channel to another). In a network configured for DL-based mobility, during a call with a network access node, or at any other time, a client device may monitor various parameters of the signal from its serving cell as well as various parameters of neighboring cells. Depending on the quality of these parameters, the client device may maintain communication with one or more of the neighboring cells. During this time, if the client device moves from one cell to another, or if signal quality from a neighboring cell exceeds that from the serving cell for a given amount of time, the client device may undertake a handoff or handover from the serving cell to the neighboring (target) cell. For example, client device 124 (illustrated as a vehicle, although any suitable form of client device may be used) may move from the geographic area corresponding to its serving cell 102 to the geographic area corresponding to a neighbor cell 106. When the signal strength or quality from the neighbor cell 106 exceeds that of its serving cell 102 for a given amount of time, the client device 124 may transmit a reporting message to its serving network access node 110 indicating this condition. In response, the client device 124 may receive a handover command, and the client device may undergo a handover to the cell 106.

In a network configured for UL-based mobility, UL reference signals from each client device may be utilized by the network to select a serving cell for each client device. In some examples, the network access nodes 110, 112, and 114/116 may broadcast unified synchronization signals (e.g., unified Primary Synchronization Signals (PSSs), unified Secondary Synchronization Signals (SSSs) and unified Physical Broadcast Channels (PBCH)). The client devices 122, 124, 126, 128, 130, and 132 may receive the unified synchronization signals, derive the carrier frequency and slot timing from the synchronization signals, and in response to deriving timing, transmit an uplink pilot or reference signal. The uplink pilot signal transmitted by a client device (e.g., client device 124) may be concurrently received by two or more cells (e.g., network access nodes 110 and 114/116) within the radio access network 100. Each of the cells may measure a strength of the pilot signal, and the radio access network (e.g., one or more of the network access nodes 110 and 114/116 and/or a central node within the core network) may determine a serving cell for the client device 124. As the client device 124 moves through the radio access network 100, the network may continue to monitor the uplink pilot signal transmitted by the client device 124. When the signal strength or quality of the pilot signal measured by a neighboring cell exceeds that of the signal strength or quality measured by the serving cell, the network 100 may handover the client device 124 from the serving cell to the neighboring cell, with or without informing the client device 124.

Although the synchronization signal transmitted by the network access nodes 110, 112, and 114/116 may be unified, the synchronization signal may not identify a particular cell, but rather may identify a zone of multiple cells operating on the same frequency and/or with the same timing. The use of zones in 5G networks or other next generation communication networks enables the uplink-based mobility framework and improves the efficiency of both the client device and the network, since the number of mobility messages that need to be exchanged between the client device and the network may be reduced.

In various implementations, the air interface in the radio access network 100 may utilize licensed spectrum, unlicensed spectrum, or shared spectrum. Licensed spectrum provides for exclusive use of a portion of the spectrum, generally by virtue of a mobile network operator purchasing a license from a government regulatory body. Unlicensed spectrum provides for shared use of a portion of the spectrum without need for a government-granted license. While compliance with some technical rules is generally still required to access unlicensed spectrum, generally, any operator or device may gain access. Shared spectrum may fall between licensed and unlicensed spectrum, wherein technical rules or limitations may be required to access the spectrum, but the spectrum may still be shared by multiple operators and/or multiple RATs. For example, the holder of a license for a portion of licensed spectrum may provide licensed shared access (LSA) to share that spectrum with other parties, e.g., with suitable licensee-determined conditions to gain access.

In some examples, access to the air interface may be scheduled, wherein a network access node allocates resources for communication among some or all devices and equipment within its service area or cell. Within the present disclosure, as discussed further below, the network access node may be responsible for scheduling, assigning, reconfiguring, and releasing resources for one or more client devices. That is, for scheduled communication, client devices or scheduled entities utilize resources allocated by the network access node.

In some examples, a client device may function as a network access node, scheduling resources for one or more scheduled entities (e.g., one or more other client devices). In other examples, sidelink signals may be used between client devices (e.g., either with scheduling from a network access node or without necessarily relying on scheduling or control information from a network access node). For example, client device 138 is illustrated communicating with client devices 140 and 142. In some examples, the client device 138 is functioning as a network access node or a primary sidelink device, and client devices 140 and 142 may function as a client device or a non-primary (e.g., secondary) sidelink device. In still another example, a client device may function as a network access node in a device-to-device (D2D), peer-to-peer (P2P), or vehicle-to-vehicle (V2V) network, and/or in a mesh network. In a mesh network example, client devices 140 and 142 may optionally communicate directly with one another in addition to communicating with the network access node 138.

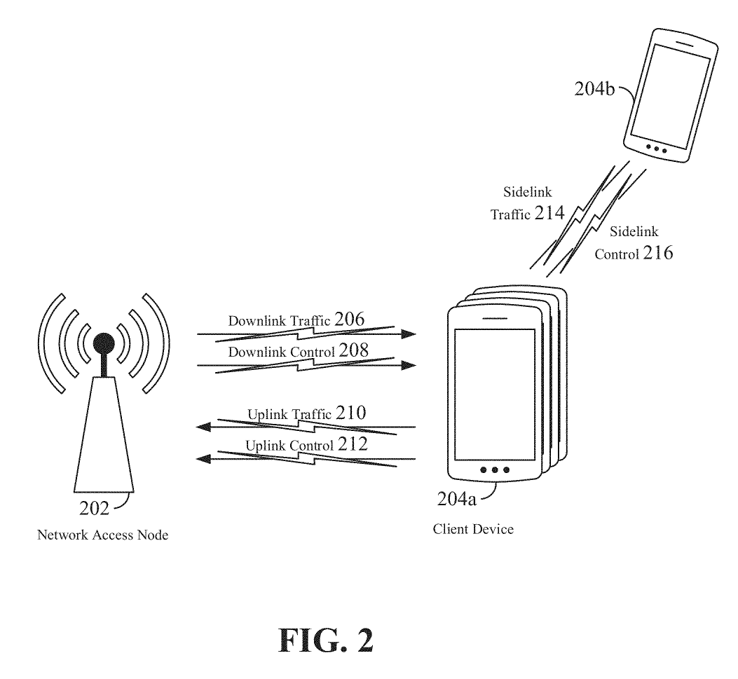

Thus, in a wireless communication network with scheduled access to time—frequency resources and having a cellular configuration, a P2P configuration, or a mesh configuration, a network access node and one or more client devices may communicate utilizing the scheduled resources. Referring now to FIG. 2, a block diagram illustrates a network access node 202 and a plurality of client devices 204 (e.g., 204a and 204b). Here, the network access node 202 may correspond to a network access node 110, 112, 114, and/or 118. In additional examples, the network access node 202 may correspond to a client device 138, the quadcopter 120, or any other suitable node in the radio access network 100. Similarly, in various examples, the client device 204 may correspond to the client device 122, 124, 126, 128, 130, 132, 134, 136, 138, 140, and 142, or any other suitable node in the radio access network 100.

As illustrated in FIG. 2, the network access node 202 may transmit downlink traffic 206 and/or downlink control traffic 208 to one or more client devices 204 (the traffic may be referred to as downlink traffic). Broadly, the network access node 202 is a node or device responsible for scheduling traffic in a wireless communication network, including the downlink transmissions and, in some examples, uplink traffic 210 and/or uplink control traffic 212 from one or more client devices to the network access node 202. Broadly, the client device 204 is a node or device that receives control information, including but not limited to scheduling information (e.g., a grant), synchronization or timing information, or other control information from another entity in the wireless communication network such as the network access node 202.

In some examples, client devices such as a first client device 204a and a second client device 204b may utilize sidelink signals for direct D2D communication. Sidelink signals may include sidelink traffic 214 and sidelink control 216. In some aspects, the sidelink traffic 214 and/or sidelink control 216 may be communicated via a PC5 interface. In such aspects, the PC5 interface may support multicarrier transmissions and/or carrier aggregation (CA). For example, when LTE-based vehicle-to-everything (V2X) communication protocols are implemented by the first client device 204a, the first client device 204a may be allowed to use multiple carriers for the transmission of V2X messages.

Sidelink control information 216 may in some examples include a request signal, such as a request-to-send (RTS), a source transmit signal (STS), and/or a direction selection signal (DSS). The request signal may provide for a client device 204 to request a duration of time to keep a sidelink channel available for a sidelink signal. Sidelink control information 216 may further include a response signal, such as a clear-to-send (CTS) and/or a destination receive signal (DRS). The response signal may provide for the client device 204 to indicate the availability of the sidelink channel, e.g., for a requested duration of time. An exchange of request and response signals (e.g., handshake) may enable different client devices performing sidelink communications to negotiate the availability of the sidelink channel prior to communication of the sidelink traffic information 214.

The air interface in the radio access network 100 may utilize one or more duplexing algorithms. Duplex refers to a point-to-point communication link where both endpoints can communicate with one another in both directions. Full duplex means both endpoints can simultaneously communicate with one another. Half duplex means only one endpoint can send information to the other at a time. In a wireless link, a full duplex channel generally relies on physical isolation of a transmitter and receiver, and suitable interference cancellation technologies. Full duplex emulation is frequently implemented for wireless links by utilizing frequency division duplex (FDD) or time division duplex (TDD). In FDD, transmissions in different directions operate at different carrier frequencies. In TDD, transmissions in different directions on a given channel are separated from one another using time division multiplexing. That is, at some times the channel is dedicated for transmissions in one direction, while at other times the channel is dedicated for transmissions in the other direction, where the direction may change very rapidly, e.g., several times per slot.

In order for transmissions over the radio access network 100 to obtain a low block error rate (BLER) while still achieving very high data rates, channel coding may be used. That is, wireless communication may generally utilize a suitable error correcting block code. In a typical block code, an information message or sequence is split up into code blocks (CBs), and an encoder (e.g., a CODEC) at the transmitting device then mathematically adds redundancy to the information message. Exploitation of this redundancy in the encoded information message can improve the reliability of the message, enabling correction for any bit errors that may occur due to the noise.

In 5G NR specifications, user data may be coded using quasi-cyclic low-density parity check (LDPC) with two different base graphs: one base graph is used for large code blocks and/or high code rates, while the other base graph is used otherwise. Control information and the physical broadcast channel (PBCH) are coded using Polar coding, based on nested sequences. For these channels, puncturing, shortening, and repetition are used for rate matching.

However, those of ordinary skill in the art will understand that aspects of the present disclosure may be implemented utilizing any suitable channel code. Various implementations of network access node 202 and client device 204 may include suitable hardware and capabilities (e.g., an encoder, a decoder, and/or a CODEC) to utilize one or more of these channel codes for wireless communication.

The air interface in the radio access network 100 may utilize one or more multiplexing and multiple access algorithms to enable simultaneous communication of the various devices. For example, 5G NR specifications provide multiple access for uplink (UL) or reverse link transmissions from client devices 122 and 124 to network access node 110, and for multiplexing for downlink (DL) or forward link transmissions from network access node 110 to one or more client devices 122 and 124, utilizing orthogonal frequency division multiplexing access (OFDM) with a cyclic prefix (CP). In addition, for UL transmissions, 5G NR specifications provide support for discrete Fourier transform-spread-OFDM (DFT-s-OFDM) with a CP (also referred to as single-carrier FDMA (SC-FDMA)). However, within the scope of the present disclosure, multiplexing and multiple access are not limited to the above schemes, and may be provided utilizing time division multiple access (TDMA), code division multiple access (CDMA), frequency division multiple access (FDMA), sparse code multiple access (SCMA), resource spread multiple access (RSMA), or other suitable multiple access schemes. Further, multiplexing downlink (DL) or forward link transmissions from the network access node 110 to client devices 122 and 124 may be provided utilizing time division multiplexing (TDM), code division multiplexing (CDM), frequency division multiplexing (FDM), orthogonal frequency division multiplexing (OFDM), sparse code multiplexing (SCM), or other suitable multiplexing schemes.

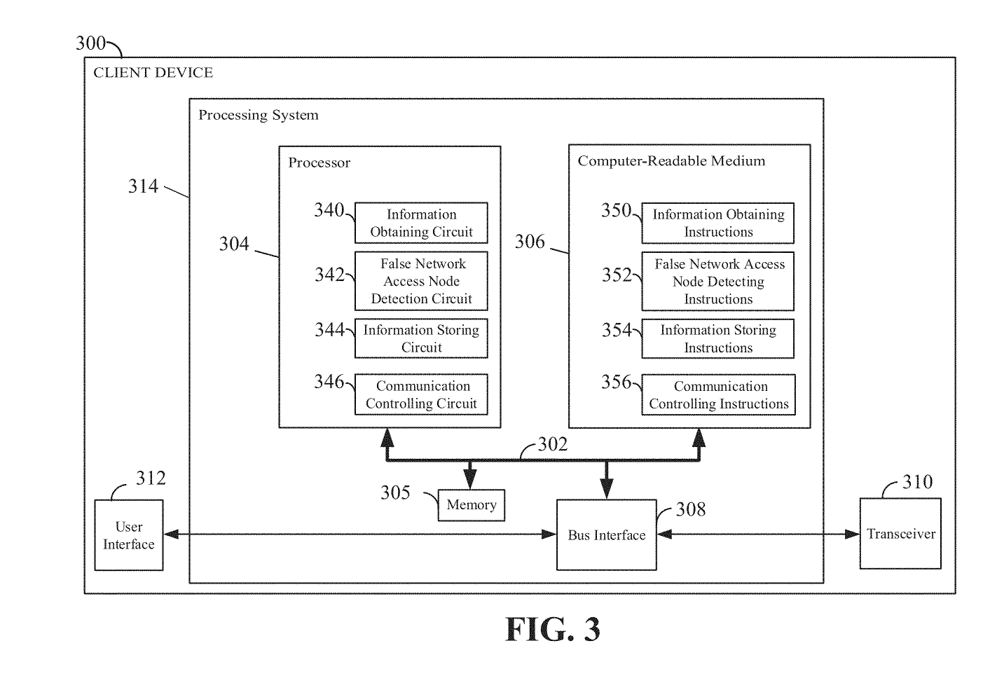

FIG. 3 is a block diagram illustrating an example of a hardware implementation for a client device 300 employing a processing system 314. For example, the client device 300 may be a client device as illustrated in any one or more of FIGS. 1, 2, 8, and/or 10.

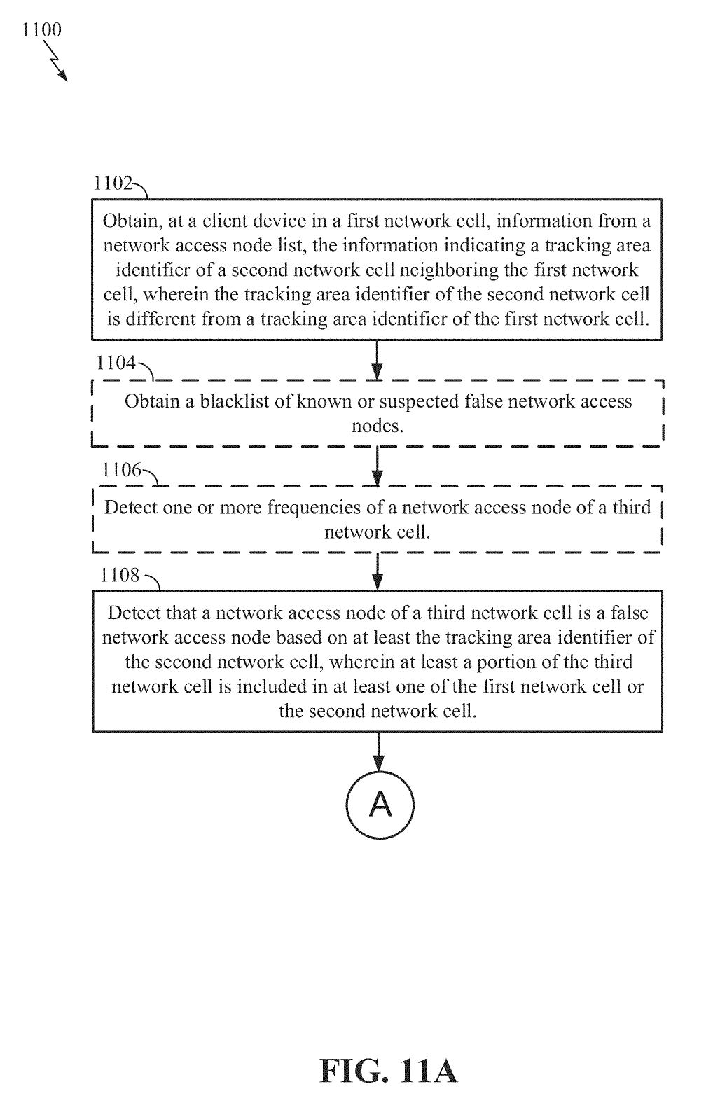

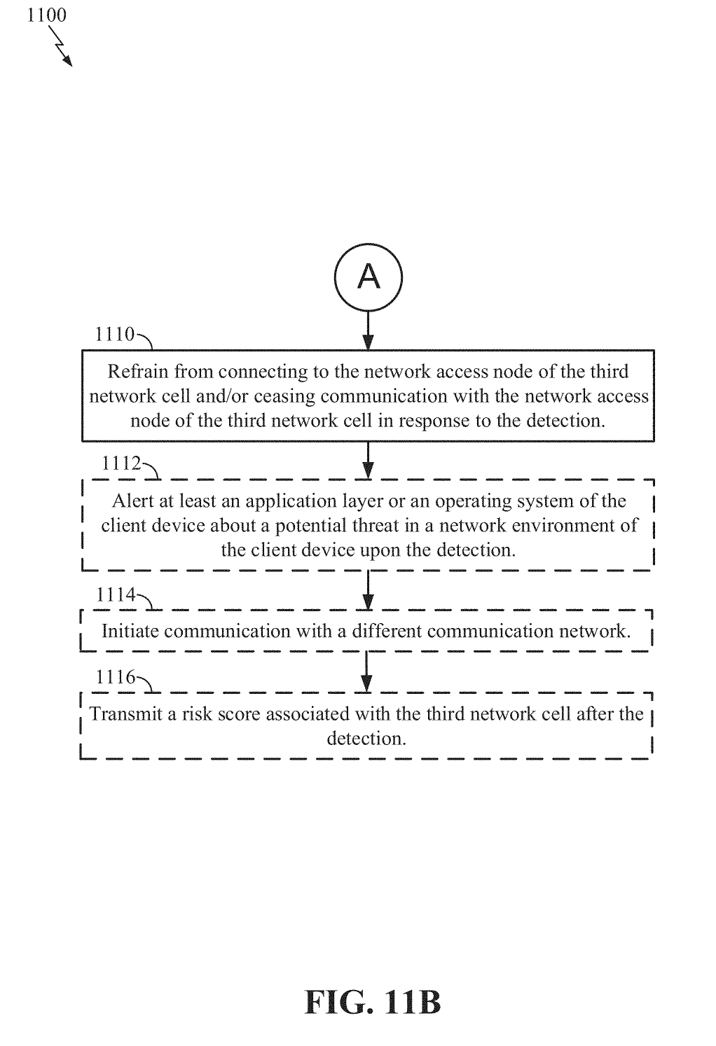

The client device 300 may be implemented with a processing system 314 that includes one or more processors 304. Examples of processors 304 include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. In various examples, the client device 300 may be configured to perform any one or more of the functions described herein. That is, the processor 304, as utilized in the client device 300, may be used to implement any one or more of the processes and procedures described below and illustrated in FIGS. 11-14.

In this example, the processing system 314 may be implemented with a bus architecture, represented generally by the bus 302. The bus 302 may include any number of interconnecting buses and bridges depending on the specific application of the processing system 314 and the overall design constraints. The bus 302 communicatively couples together various circuits including one or more processors (represented generally by the processor 304), a memory 305, and computer-readable media (represented generally by the computer-readable medium 306). The bus 302 may also link various other circuits such as timing sources, peripherals, voltage regulators, and power management circuits, which are well known in the art, and therefore, will not be described any further. A bus interface 308 provides an interface between the bus 302 and a transceiver 310. The transceiver 310 provides a communication interface or means for communicating with various other apparatus over a transmission medium. Depending upon the nature of the apparatus, a user interface 312 (e.g., keypad, display, speaker, microphone, joystick) may also be provided.

In some aspects of the disclosure, the processor 304 may include an information obtaining circuit 340 configured for various functions, including, for example, obtaining, in a first network cell, information from a network access node list (also referred to as a geographical whitelist database of authentic network access nodes), the information indicating a tracking area identifier of a second network cell neighboring the first network cell, wherein the tracking area identifier of the second network cell is different from a tracking area identifier of the first network cell, obtaining a blacklist of known or suspected false network access nodes, obtaining, in a first geographical location, at least one portion of a network access node list associated with a second geographical location, wherein the second geographical location is an intended destination of the client device, and/or obtaining future availability information from a network access node list, the future availability information including at least an indication that a network access node operates intermittently, a periodic ON/OFF switching pattern of the network access node, aperiodic ON/OFF future time values listed as a vector of time values for the network access node, or one or more future time periods during which the network access node will be operating, wherein the availability information is based on information gathered from at least a public information system, a publicly available source, or a website. For example, the information obtaining circuit 340 may be configured to implement one or more of the functions described below in relation to FIGS. 11-14, including, e.g., blocks 1102, 1104, 1202, 1302 and/or 1402.

In some aspects of the disclosure, the processor 304 may include a false network access node detection circuit 342 configured for various functions, including, for example, detecting that a network access node of a third network cell is a false network access node based on at least the tracking area identifier of the second network cell, wherein at least a portion of the third network cell is included in at least one of the first network cell or the second network cell, detecting that a network access node in or near the second network cell is a false network access node based on at least the information from the network access node list, alerting at least an application layer or an operating system of the client device about a potential threat in a network environment of the client device upon the detection, transmitting a risk score associated with the network access node of the third network cell after the detection, transmitting a risk score associated with the network access node in or near the second network cell, detecting that a network access node observed in the second geographical location is a false network access node based on the at least one portion of the network access node list, and/or detecting one or more frequencies of a network access node of a third network cell. For example, the false network access node detection circuit 342 may be configured to implement one or more of the functions described below in relation to FIGS. 11-13, including, e.g., blocks 1106, 1108, 1112, 1116, 1204, 1208, 1212, and/or 1310.

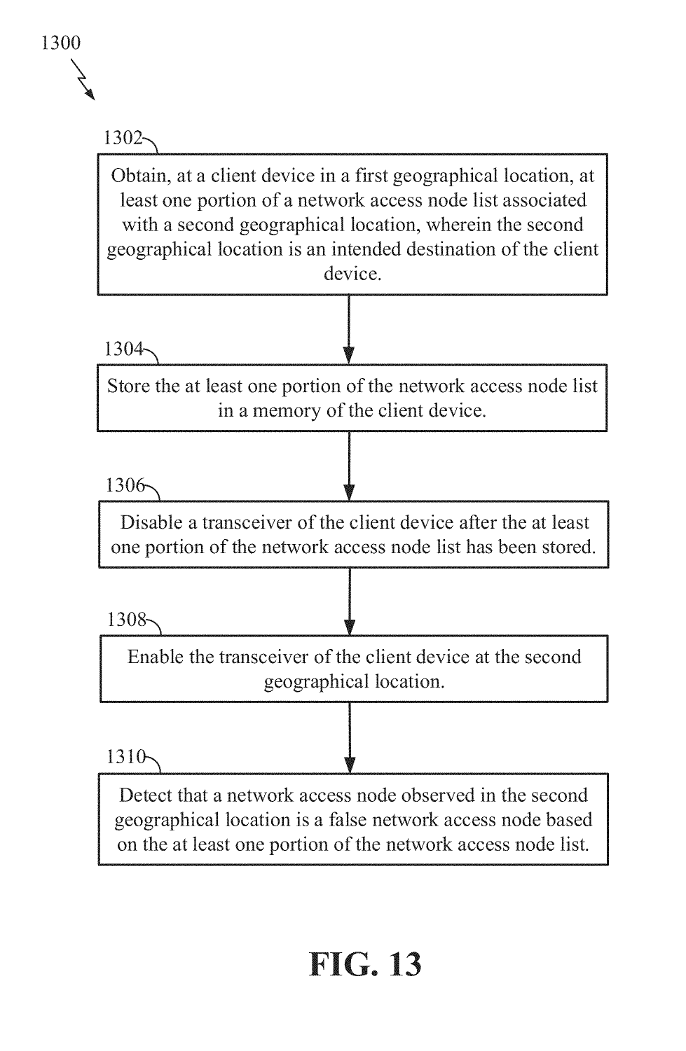

In some aspects of the disclosure, the processor 304 may include an information storing circuit 344 configured for various functions, including, for example, storing the at least one portion of the network access node list in a memory of the client device. For example, the information storing circuit 344 may be configured to implement one or more of the functions described below in relation to FIG. 13, including, e.g., block 1304.

In some aspects of the disclosure, the processor 304 may include a communication controlling circuit 346 configured for various functions, including, for example, refraining from connecting to the network access node of the third network cell and/or ceasing communication with the network access node of the third network cell in response to the detection, ceasing communication with the network access node in or near the second network cell upon the detection, initiating communication with a different communication network, disabling a transceiver of the client device after the at least one portion of the network access node list has been stored, enabling the transceiver of the client device at the second geographical location, and/or communicating with the network access node based on the future availability information from the network access node list. For example, the communication controlling circuit 346 may be configured to implement one or more of the functions described below in relation to FIGS. 11-14, including, e.g., blocks 1110, 1114, 1206, 1210, 1306, 1308, and 1404.

The processor 304 is responsible for managing the bus 302 and general processing, including the execution of software stored on the computer-readable medium 306. The software, when executed by the processor 304, causes the processing system 314 to perform the various functions described below for any particular apparatus. The computer-readable medium 306 and the memory 305 may also be used for storing data that is manipulated by the processor 304 when executing software.

One or more processors 304 in the processing system may execute software.

Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. The software may reside on a computer-readable medium 306. The computer-readable medium 306 may be a non-transitory computer-readable medium. A non-transitory computer-readable medium includes, by way of example, a magnetic storage device (e.g., hard disk, floppy disk, magnetic strip), an optical disk (e.g., a compact disc (CD) or a digital versatile disc (DVD)), a smart card, a flash memory device (e.g., a card, a stick, or a key drive), a random access memory (RAM), a read only memory (ROM), a programmable ROM (PROM), an erasable PROM (EPROM), an electrically erasable PROM (EEPROM), a register, a removable disk, and any other suitable medium for storing software and/or instructions that may be accessed and read by a computer. The computer-readable medium 306 may reside in the processing system 314, external to the processing system 314, or distributed across multiple entities including the processing system 314. The computer-readable medium 306 may be embodied in a computer program product. By way of example, a computer program product may include a computer-readable medium in packaging materials. Those skilled in the art will recognize how best to implement the described functionality presented throughout this disclosure depending on the particular application and the overall design constraints imposed on the overall system.

In one or more examples, the computer-readable storage medium 306 may include information obtaining instructions 350 configured for various functions, including, for example, obtaining, in a first network cell, information from a network access node list (also referred to as a geographical whitelist database of authentic network access nodes), the information indicating a tracking area identifier of a second network cell neighboring the first network cell, wherein the tracking area identifier of the second network cell is different from a tracking area identifier of the first network cell, obtaining a blacklist of known or suspected false network access nodes, obtaining, in a first geographical location, at least one portion of a network access node list associated with a second geographical location, wherein the second geographical location is an intended destination of the client device, and/or obtaining future availability information from a network access node list, the future availability information including at least an indication that a network access node operates intermittently, a periodic ON/OFF switching pattern of the network access node, aperiodic ON/OFF future time values listed as a vector of time values for the network access node, or one or more future time periods during which the network access node will be operating, wherein the availability information is based on information gathered from at least a public information system, a publicly available source, or a website. For example, the information obtaining instructions 350 may be configured to implement one or more of the functions described above in relation to FIGS. 11-14, including, e.g., blocks 1102, 1104, 1202, 1302 and/or 1402.

In one or more examples, the computer-readable storage medium 306 may include false network access node detecting instructions 352 configured for various functions, including, for example, detecting that a network access node of a third network cell is a false network access node based on at least the tracking area identifier of the second network cell, wherein at least a portion of the third network cell is included in at least one of the first network cell or the second network cell, detecting that a network access node in or near the second network cell is a false network access node based on at least the information from the network access node list, alerting at least an application layer or an operating system of the client device about a potential threat in a network environment of the client device upon the detection, transmitting a risk score associated with the network access node of the third network cell after the detection, transmitting a risk score associated with the network access node in or near the second network cell, detecting that a network access node observed in the second geographical location is a false network access node based on the at least one portion of the network access node list, and/or detecting one or more frequencies of a network access node of a third network cell. For example, the false network access node detection instructions 352 may be configured to implement one or more of the functions described above in relation to FIGS. 11-13, including, e.g., blocks 1106, 1108, 1112, 1116, 1204, 1208, 1212, and/or 1310.

In one or more examples, the computer-readable storage medium 306 may include information storing instructions 354 configured for various functions, including, for example, storing the at least one portion of the network access node list in a memory of the client device. For example, the information storing instructions 354 may be configured to implement one or more of the functions described above in relation to FIG. 13, including, e.g., block 1304.

In one or more examples, the computer-readable storage medium 306 may include communication controlling instructions 356 configured for various functions, including, for example, refraining from connecting to the network access node of the third network cell and/or ceasing communication with the network access node of the third network cell in response to the detection, ceasing communication with the network access node in or near the second network cell upon the detection, initiating communication with a different communication network, disabling a transceiver of the client device after the at least one portion of the network access node list has been stored, enabling the transceiver of the client device at the second geographical location, and/or communicating with the network access node based on the future availability information from the network access node list. For example, the communication controlling instructions 356 may be configured to implement one or more of the functions described above in relation to FIGS. 11-14, including, e.g., blocks 1110, 1114, 1206, 1210, 1306, 1308, and/or 1404.

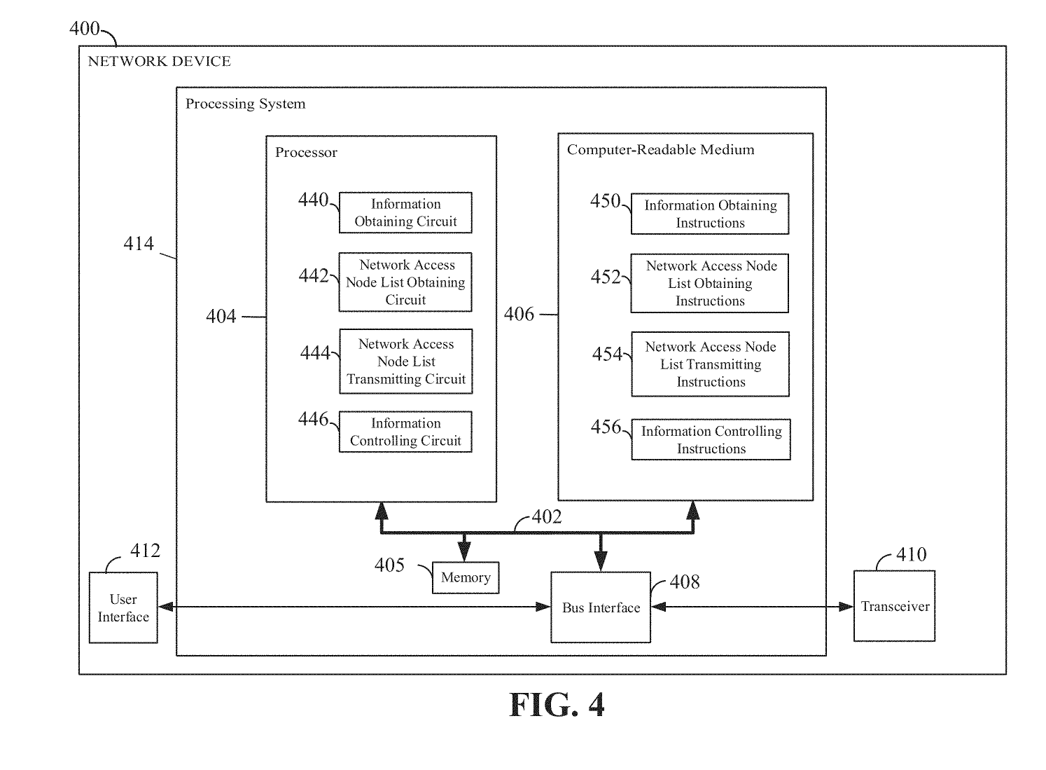

FIG. 4 is a conceptual diagram illustrating an example of a hardware implementation for an exemplary network device 400 employing a processing system 414. In accordance with various aspects of the disclosure, an element, or any portion of an element, or any combination of elements may be implemented with a processing system 414 that includes one or more processors 404.

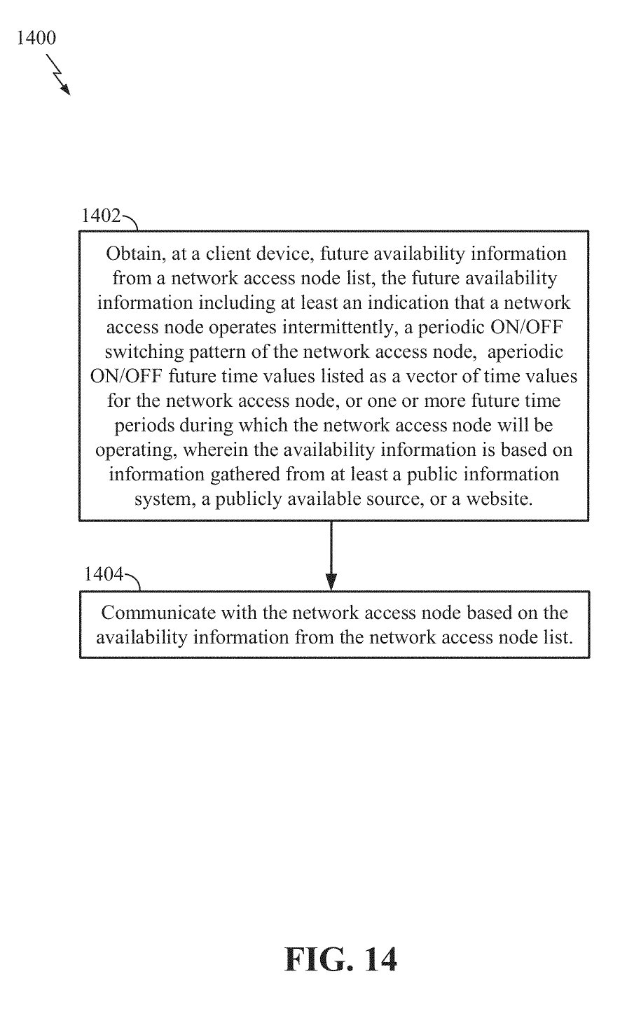

The processing system 414 may be substantially the same as the processing system 314 illustrated in FIG. 3, including a bus interface 408, a bus 402, memory 405, a processor 404, and a computer-readable medium 406. Furthermore, the network device 400 may include a user interface 412 and a transceiver 410 substantially similar to those described above in FIG. 3. That is, the processor 404, as utilized in the network device 400, may be used to implement any one or more of the processes and procedures described below and illustrated in FIGS. 14-17. In some aspects of the disclosure, the network device 400 may be implemented as a network module or a network server.

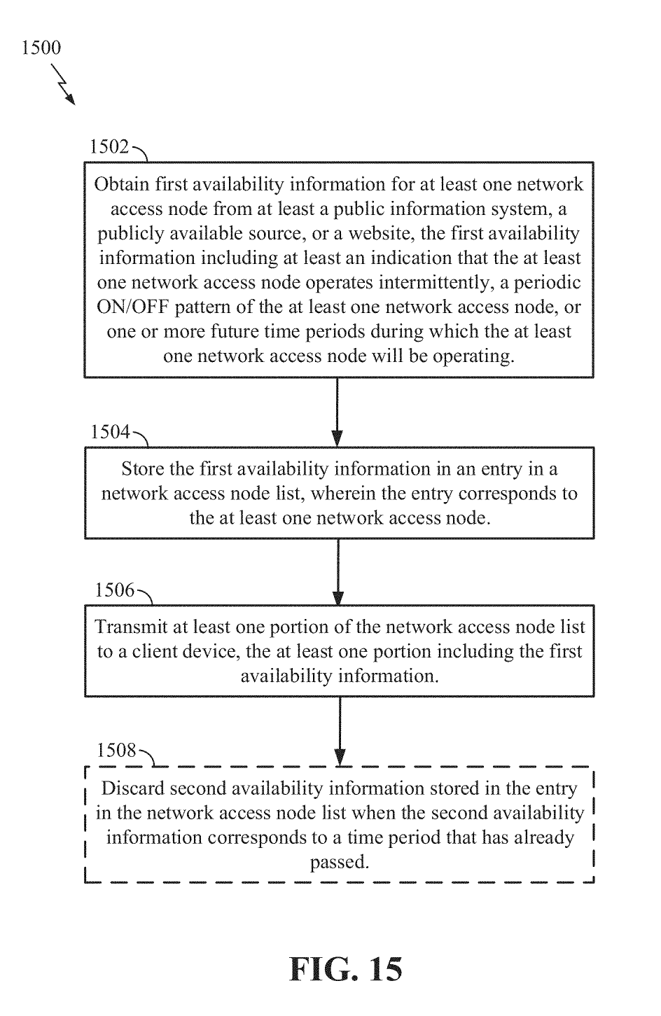

In some aspects of the disclosure, the network device 400 may include an information obtaining circuit 440 configured for various functions, including, for example, obtaining first availability information for at least one network access node from at least a public information system, a publicly available source, or a website, the first availability information including at least an indication that the at least one network access node operates intermittently, a periodic ON/OFF pattern of the at least one network access node, or one or more future time periods during which the at least one network access node will be operating, storing the first availability information in an entry in a network access node list, wherein the entry corresponds to the at least one network access node, obtaining network cell transition information from one or more client devices, the network cell transition information indicating that a tracking area identifier change has been detected by the one or more client devices when leaving a first network cell and entering a second network cell, wherein the first network cell neighbors the second network cell, obtaining a direction of the second network cell relative to the first network cell, obtaining a plurality of risk scores for at least the second network cell from the plurality of client devices, obtaining information from one or more client devices, wherein the information includes at least a notification that a mutual authentication procedure with a network access node has failed, a risk score indicating a probability that the network access node is a false network access node, one or more frequencies an operator has used for the network access node, or one or more tracking area codes assigned to the network access node at different time periods, determining that the network access node uses the one or more tracking area codes at the different time periods based on the information, and/or determining one or more time durations and corresponding tracking area codes for the network access node based on the information. For example, the information obtaining circuit 440 may be configured to implement one or more of the functions described below in relation to FIGS. 15-17, including, e.g., blocks 1502, 1602, 1604, 1606, 1702, 1708, 1712 and/or 1716.

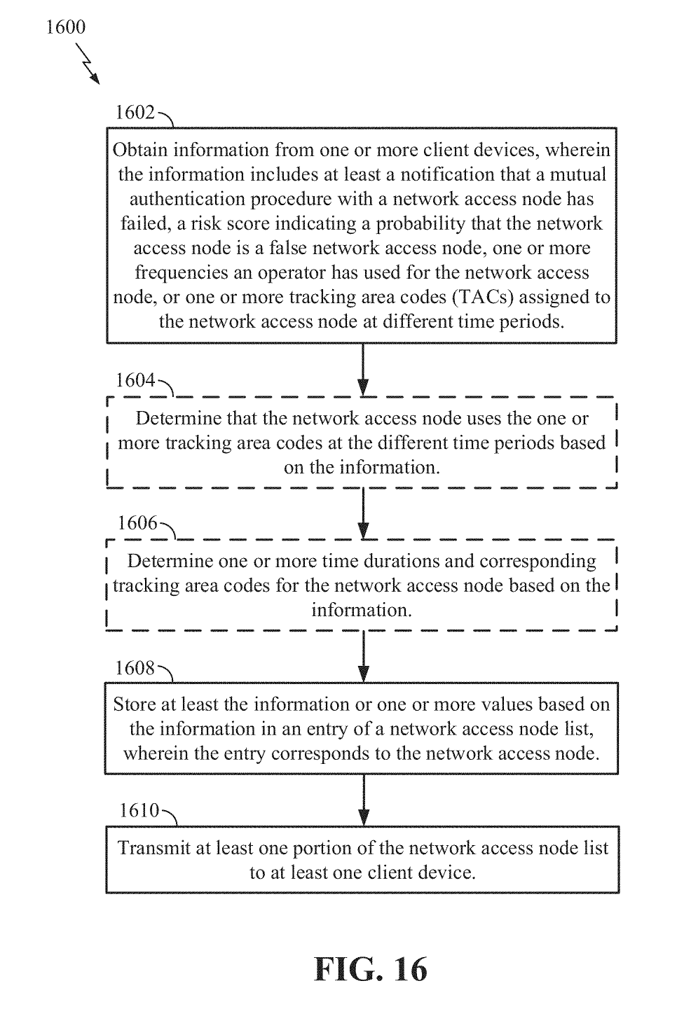

The processor 404 may include a network access node list obtaining circuit 442 configured for various functions, including, for example, obtaining a network access node list that includes the at least one network access node and the availability information, storing the network cell transition information in an entry in a network access node list, wherein the entry corresponds to the first network cell or a network access node that supports the first network cell, storing the direction in the entry in the network access node list, storing the single risk score in the entry in the network access node list, and/or storing at least the information or one or more values based on the information in an entry of a network access node list, wherein the entry corresponds to a network access node. For example, the network access node list obtaining circuit 442 may be configured to implement one or more of the functions described below in relation to FIGS. 15 and 16, including, e.g., blocks 1504, 1608.

The processor 404 may include a network access node list transmitting circuit 444 configured for various functions, including, for example, transmitting at least one portion of the network access node list to a client device, the at least one portion including the first availability information, transmitting at least one portion of the network access node list to a client device, the at least one portion including the network cell transition information, and/or transmitting the single risk score to the client device. For example, the network access node list transmitting circuit 444 may be configured to implement one or more of the functions described below in relation to FIGS. 15-17, including, e.g., blocks 1506, 1610, 1706, and/or 1718.

The processor 404 may include an information controlling circuit 446 configured for various functions, including, for example, discarding second availability information stored in the entry in the network access node list when the second availability information corresponds to a time period that has already passed, and/or consolidating the plurality of risk scores into a single risk score. For example, the information controlling circuit 446 may be configured to implement one or more of the functions described below in relation to FIG. 15, including, e.g., block 1508.

In one or more examples, the computer-readable storage medium 406 may include information obtaining instructions 450, configured for various functions, including, for example, obtaining first availability information for at least one network access node from at least a public information system, a publicly available source, or a website, the first availability information including at least an indication that the at least one network access node operates intermittently, a periodic ON/OFF pattern of the at least one network access node, or one or more future time periods during which the at least one network access node will be operating, storing the first availability information in an entry in a network access node list, wherein the entry corresponds to the at least one network access node, obtaining network cell transition information from one or more client devices, the network cell transition information indicating that a tracking area identifier change has been detected by the one or more client devices when leaving a first network cell and entering a second network cell, wherein the first network cell neighbors the second network cell, obtaining a direction of the second network cell relative to the first network cell, obtaining a plurality of risk scores for at least the second network cell from the plurality of client devices, obtaining information from one or more client devices, wherein the information includes at least a notification that a mutual authentication procedure with a network access node has failed, a risk score indicating a probability that the network access node is a false network access node, one or more frequencies an operator has used for the network access node, or one or more tracking area codes assigned to the network access node at different time periods, determining that the network access node uses the one or more tracking area codes at the different time periods based on the information, and/or determining one or more time durations and corresponding tracking area codes for the network access node based on the information. For example, the information obtaining instructions 450 may be configured to implement one or more of the functions described below in relation to FIGS. 15-17, including, e.g., blocks 1502, 1602, 1604, 1606, 1702, 1708, 1712 and/or 1716.

The computer-readable storage medium 406 may further include network access node list obtaining instructions 452, configured for various functions, including, for example, obtaining a network access node list that includes the at least one network access node and the availability information, storing the network cell transition information in an entry in a network access node list, wherein the entry corresponds to the first network cell or a network access node that supports the first network cell, storing the direction in the entry in the network access node list, storing the single risk score in the entry in the network access node list, and/or storing at least the information or one or more values based on the information in an entry of a network access node list, wherein the entry corresponds to a network access node. For example, the network access node list obtaining instructions 452 may be configured to implement one or more of the functions described below in relation to FIGS. 15 and 16, including, e.g., blocks 1504, 1608.

The computer-readable storage medium 406 may further include network access node list transmitting instructions 454, configured for various functions, including, for example, transmitting at least one portion of the network access node list to a client device, the at least one portion including the first availability information, transmitting at least one portion of the network access node list to a client device, the at least one portion including the network cell transition information, and/or transmitting the single risk score to the client device. For example, the network access node list transmitting instructions 454 may be configured to implement one or more of the functions described below in relation to FIGS. 15-17, including, e.g., blocks 1506, 1610, 1706, and/or 1718.

The computer-readable storage medium 406 may further include information controlling instructions 456, configured for various functions, including, for example, discarding second availability information stored in the entry in the network access node list when the second availability information corresponds to a time period that has already passed, and/or consolidating the plurality of risk scores into a single risk score. For example, the information controlling instructions 456 may be configured to implement one or more of the functions described below in relation to FIG. 15, including, e.g., block 1508.

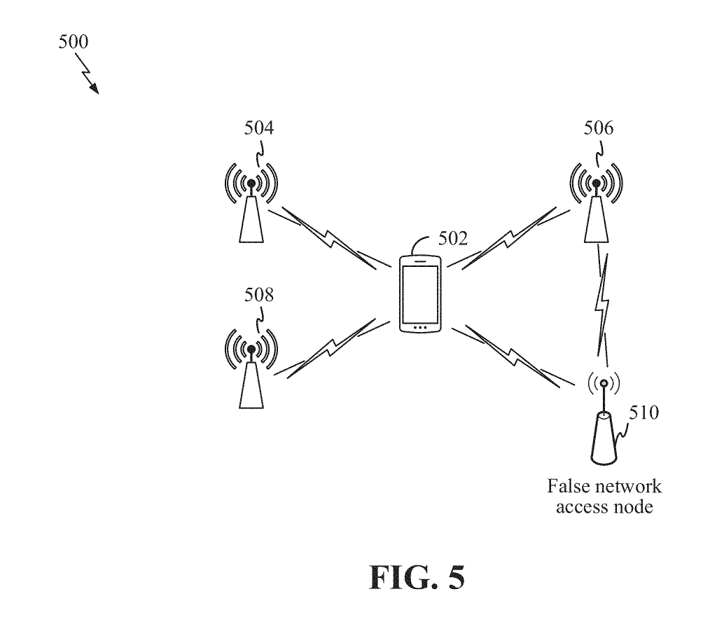

3G mobile communication networks have brought mutual authentication, stronger and well-analyzed cryptographic algorithms as compared to 2G/Global System for Mobile communications (GSM) networks. 4G/Long Term Evolution (LTE) networks further strengthened the security features, thereby providing improved privacy and security to mobile users. Attacks, such as man-in-the-middle (MITM) attacks using false network access nodes (also referred to as fake network access nodes or fake base stations), have become more difficult in 3G/Universal Mobile Telecommunications System (UMTS) networks and 4G/LTE networks as compared to 2G/GSM networks. FIG. 5 illustrates an example network configuration 500 showing a man-in-the-middle attack. As shown in FIG. 5, a client device 502 may be communicating with one or more of the authentic network access nodes 504, 506, and 508 of a mobile communication network (e.g., LTE). As further shown in FIG. 5, for example, a false network access node 510 may be deployed by an attacker to control the client device 502 and/or the authentic network access node 506.

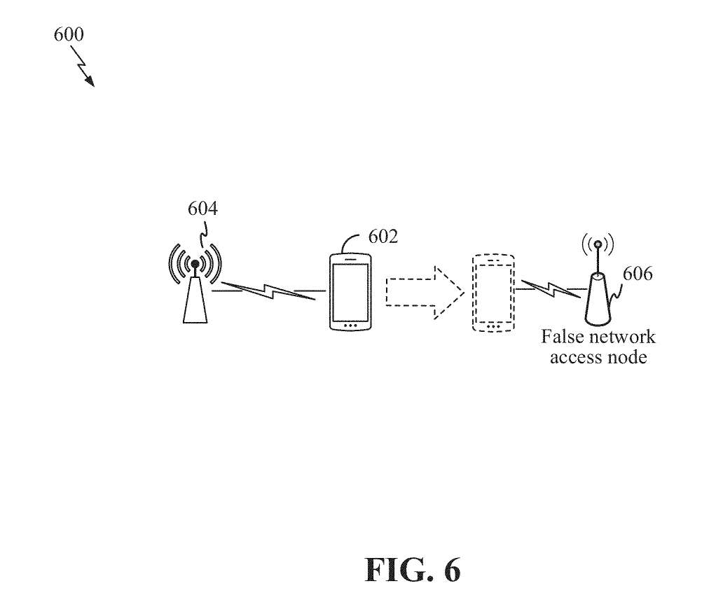

However, LTE is vulnerable to newer attacks, such as privacy info leaks, location tracking, denial of service, fake Short Message Service (SMS) messages with phishing attacks, eavesdropping on phone calls and text messages, spam with malicious links that inject malware/spyware onto mobile phones, and downgrade attacks to 2G with weak or no encryption. FIG. 6 illustrates an example network configuration 600 showing a client device under attack by a false network access node. As shown in FIG. 6, a client device 602 may be communicating with an authentic network access node 604 of a mobile communication network (e.g., LTE). As further shown in FIG. 6, a false network access node 606 may be deployed by an attacker and may cause the client device 602 to establish a connection with the false network access node 606. The false network access node 606 may then trick the client device 602 into providing identity information (e.g., an International Mobile Subscriber Identity (IMSI)) and/or may limit the client device 602 to particular radio access network (e.g., a downgraded radio access network, such as a 2G network). In some cases, the false network access node 606 may prevent the client device 602 from connecting to a mobile communication network (e.g., a denial of service (DOS) attack).

In addition, femto cells are being increasingly used as operator provided extensions into areas where coverage from standard network access nodes (also referred to as standard base stations) is difficult to achieve. For example, femto cells may provide improved cellular coverage inside a home or for certain events with a large gathering of people. However, these femto cells may be more vulnerable to attack. For example, a malicious user may configure a false femto network access node (also referred to as a false femto base station) to operate as a standard network access node with malicious intent. It is currently very difficult for a client device to detect false femto network access nodes.

False network access nodes in 3G and/or 4G networks have already been observed in the U.S., China, India, Russia, Israel, and the United Kingdom. In China alone, it has been reported that users received over 2.9 billion, 4.2 billion, and 5.7 billion spam/fraud messages from false network access nodes in 2013, 2014, and 2015, respectively, causing estimated losses of billions of dollars. It is estimated that an attacker with a $700 fake network access node, which may be small enough to mount inside a car, can earn up to $1400 a day. The materials and equipment needed for creating a false network access node are inexpensive and readily available today. Attacks in 3G/UMTS networks and/or 4G/LTE networks may occur within a relatively small window of opportunity, which may be before the mutual authentication mechanism sets up the secure connection between a client device and the core network.

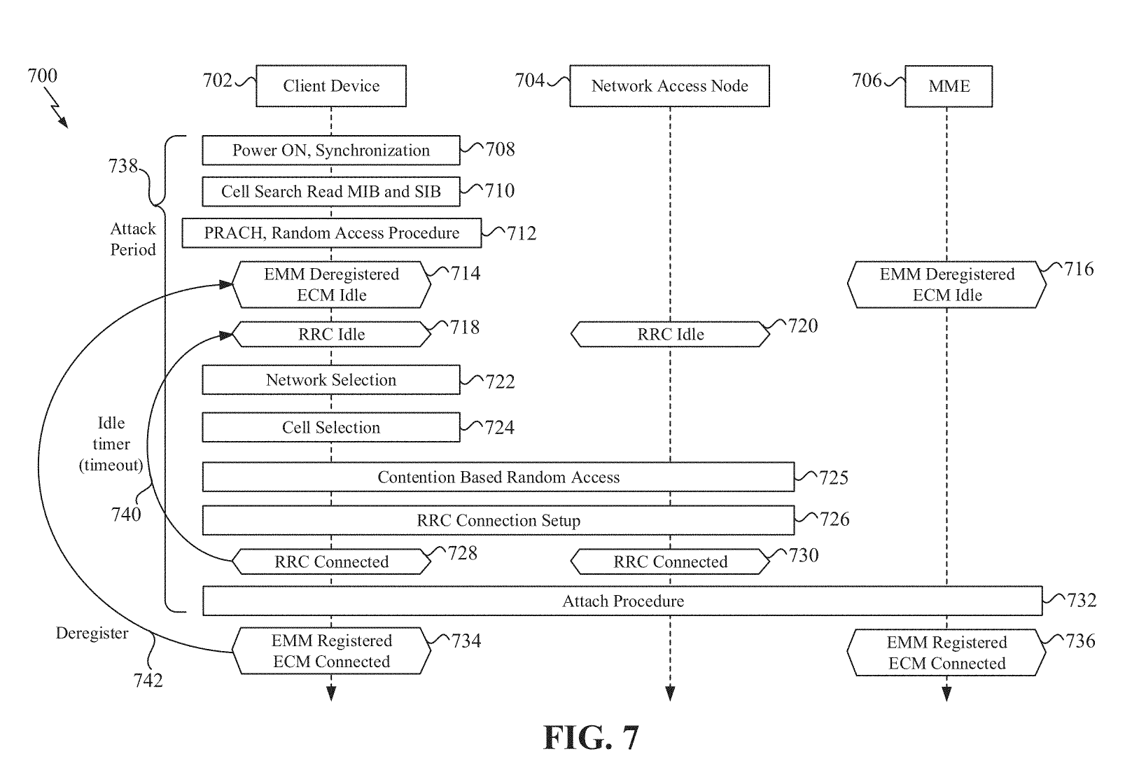

FIG. 7 illustrates an example attach procedure for a client device 702 in a communication network that includes at least a network access node 704 and a mobility management entity (MME) 706. As shown in FIG. 7, the client device 702 may power on 708, and may perform a cell search operation 710 and a random access procedure 712. The client device 702 and the MME 706 may enter an Evolved Packet System (EPS) mobility management (EMM) deregistered state and a mobile enterprise content management (ECM) idle state 714, 716. The client device 702 and the network access node 704 may enter a radio resource control (RRC) idle mode 718, 720. The client device 702 may perform network selection 722 and initial cell selection 724, followed by a contention based random access operation 725 and an RRC connection setup 726. The client device 702 and the network access node 704 may enter an RRC connected mode 728, 730. The client device 702, network access node 704, and MME 706 may perform an attach procedure 732. The client device 702 and the MME 706 may enter an EMM registered state and an ECM connected state 734, 736. As shown in FIG. 7, as per 3GPP specifications there may be a few reasons that can lead to deregistering (e.g., indicated with arrow 742 in FIG. 7) of the client device 702 while in the EMM registered state and an ECM connected state 734, leading the client device 702 to enter the EMM deregistered state and ECM idle state 714. Also shown in FIG. 7, when an idle timer of the client device 702 expires (e.g., indicated with arrow 740 in FIG. 7) while in the RRC Connected State 728, the client device 702 may enter RRC idle state 718. The client device 702 may then perform an idle mode cell reselection operation (e.g., at least performing operation 724).

In one example, the previously described small window of opportunity may occur during an attach procedure (e.g., the attack period 738 in FIG. 7) for the client device 702, such as during initial cell selection and/or when the client device is in idle mode during cell reselection. In another example, the previously described small window of opportunity may occur in the context of EMM, such as during a cell re-selection operation with a location area or tracking area update (e.g., when a new tracking area identifier (TAI) not in the client device's TAI list) where the security context needs to be re-established. However, even though the previously described window of opportunity may be relatively small, the damage resulting from attacks/exploits perpetrated by an attacker within such a small window may be severe. It is difficult for a client device to detect such attacks early in the attack window due to the limited availability of the surrounding network access nodes' system information before cell synchronization, camping, and cell selection. As such, the attack detection mechanisms for 2G/GSM network are significantly less effective for detecting attacks in a 3G/4G network.

Various conventional approaches may be used to detect false network access nodes with focus on 2G/GSM networks and extending towards 3G/4G networks. Such approaches may involve: 1) network access node identification using system information; 2) cellular protocol activities between a client device and a network access node (e.g., identification request, Attach, Detach, RRC Reject, tracking area code (TAC) Reject, Downgrade, considering their frequency of occurrence); and/or 3) use of a geographical whitelist database of the authentic network access nodes as a reference. However, existing databases that include geographical location maps of authentic network access nodes (e.g., OpenCellID, gammap org, etc.) contain mostly the system information and the geographical coordinates of the network access nodes, which are not sufficient.

The disclosure herein describes new items of information (e.g., new parameters) to be obtained and stored in a geographical whitelist database of authentic network access nodes (also referred to as a geographical whitelist database or a network access node list), describes how the new parameters or items of information can be obtained for the purpose of storing them in the whitelist database with the respective network access nodes, new logic to determine the time and the scope of the data to be accessed by a client device, when/what/how much data to be cached on the client device to substantially improve identification of false network access nodes with greater accuracy and reduced false positives. The approaches and techniques disclosed herein may enable a client device to detect false network access nodes that typically operate in a transient manner, such that the client device may distinguish these false network access nodes from temporarily or occasionally used authentic network access nodes. For example, an authentic network access node may be used (e.g., activated or turned ON to provide service to mobile clients) to cover large events (e.g., a professional sporting event at a stadium), but may not be used at other times. In some scenarios, the previously described false network access nodes may be portable, which may allow an attacker to deploy one or more of the false network access nodes near an authentic network access node.

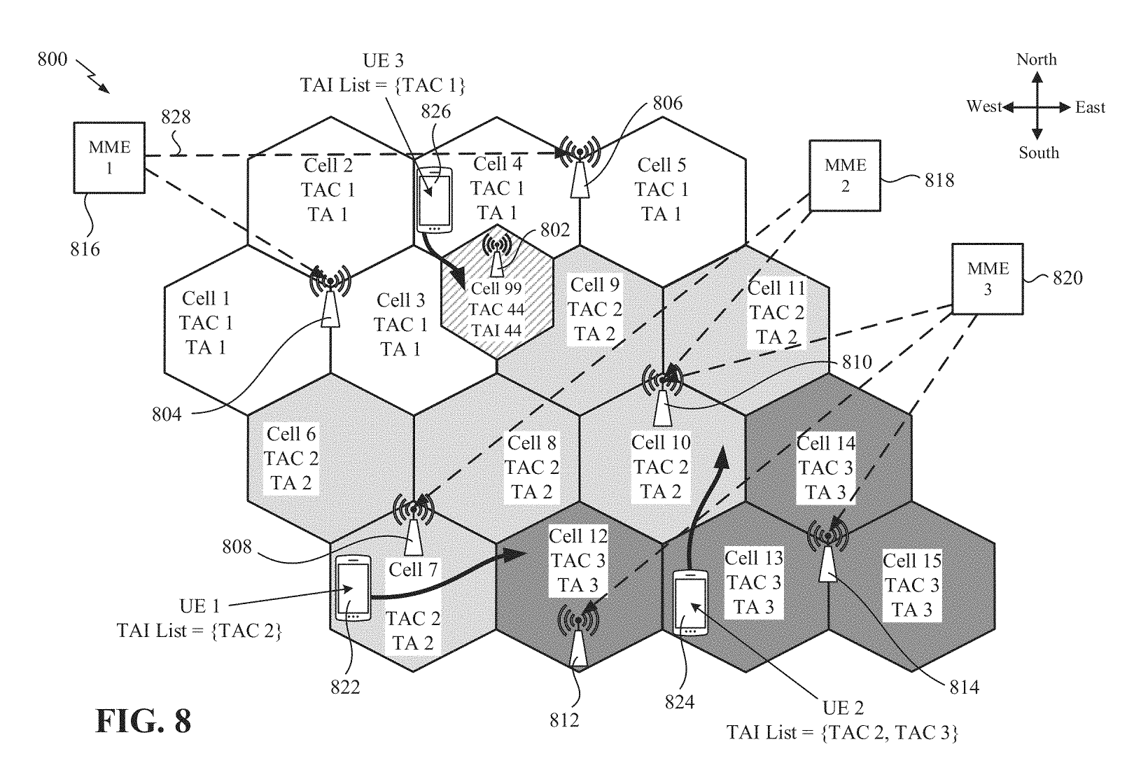

FIG. 8 illustrates an example configuration of a mobile communication network 800. As shown in FIG. 8, the mobile communication network 800 includes authentic cells 1 through 15, MME 1 816, MME 2 818, MME 3 820, client devices 822, 824, and 826 (also respectively referred to as UE 1, UE 2, and UE 3 in FIG. 8) and a false network access node 802 that advertises itself as a cell with Cell ID 99. As further shown in FIG. 8, cells 1-3 may be served by a first network access node 804, cells 4 and 5 may be served by a second network access node 806, cells 6-8 may be served by a third network access node 808, cells 9-11 may be served by a fourth network access node 810, cell 12 may be served by a fifth network access node 812, and cells 13-15 may be served by a sixth network access node 814.

As shown in the example configuration of FIG. 8, the false network access node 802 partially overlays authentic network cells 3, 4, and 9. In the example scenario of FIG. 8, the false network access node 802 may be advertising itself as belonging to TAC 44, which is substantially different from all the TACs (1, 2, and 3) in the geographical area, creating a highly likely situation of triggering a tracking area code update procedure to trick a client device (e.g., client device 826 in FIG. 8) to connect to the false network access node 802. As shown in FIG. 8, cells 1 through 5 are each assigned a tracking area code 1 (TAC 1), cells 6 through 11 are each assigned a tracking area code 2 (TAC 2), cells 12 through 15 are each assigned a tracking area code 3 (TAC 3). It should be noted that cells assigned to the same tracking area code in FIG. 8 have the same type of shading. For example, cells 1 through 5 assigned to tracking area code 1 have no shading, cells 6 through 11 assigned to tracking area code 2 have light gray shading, and cells 12 through 15 assigned to tracking area code 3 have dark gray shading. It should be noted that cells with In FIG. 8, each cell may be served by a network access node, such as the network access node 804.

A tracking area code (TAC) is a unique code that each operator assigns to each of their tracking areas (TAs). A TAI may include a public land mobile network (PLMN) ID and a TAC. The PLMN ID, which may be a combination of a mobile country code (MCC) and a mobile network code (MNC), is the unique code assigned to each operator in the world. This makes a TAI uniquely identified globally. In the aspects described herein, a TAI value may be represented as a tracking area (TA) (e.g., tracking area 1 (TA 1), tracking area 2 (TA 2), etc.) or as a TAC value (e.g., TAC 1, TAC2, etc.) that corresponds to a tracking area.

In FIG. 8, the MME 1 816 serves the network access nodes 804 and 806 as shown with dashed arrows, such as the dashed arrow 828. The MME 2 818 serves the network access nodes 808 and 810, and the MME 3 820 serves the network access nodes 810, 812, and 814. An MME (e.g., MME 1 816, MME 2 818, MME 3 820 in FIG. 8) in a mobile communication network (e.g., an LTE network) needs to be updated about the location information of client devices when the client devices are in an idle state. This enables the MME to determine the tracking area in which a particular client device is located. A client device may notify the LTE network (e.g., MME 1 816, MME 2 818, MME 3 820 in FIG. 8) about its current location by sending a tracking area update (TAU) request message every time it moves between tracking areas. The TAI list is provided to the client device by the MME when it attaches to an LTE network. The TAI list shows the tracking areas (TAs) where the LTE network believes a client device is located and within which a client device can travel without a tracking area update procedure. For example, with reference to FIG. 8, the client device 822 may be provided a TAI list “{TAC 2 or TA 2}”, the client device 824 may be provided a TAI list “{TAC 2, TAC 3 or TA 2, TA 3}”, and the client device 826 may be provided a TAI list “{TAC 1 or TA 1}”. A TAI list “{TAC 1}”, for example, means a client device does not have to send a TAU request message when it stays in tracking area 1 (TA 1) (e.g., which corresponds to TAC 1), but must send a TAU request message when it moves to tracking area 2 (TA 2) or tracking area 3 (TA 3) as these tracking areas are not indicated in the client device's TAI list (e.g., since the TAI list does not include TAC 2 or TAC 3).

In one example scenario, a client device may move between two cells in two different tracking areas (e.g., from a current cell in a first tracking area identified with a first TAC to a new cell in a second tracking area identified with a second TAC), and the TAC of the new cell may not be in the TAI list of the client device. In such a scenario, if the MMEs serving the two cells are also different, and the MMEs do not belong to a shared pool of MMEs, it is highly likely that the new cell and it's MME may not recognize the client device forcing an EMM deregistration, where the RRC will be disconnected followed by the EMM deregistration. As such, the client device would need to start the entire network selection, cell reselection, RRC connection setup, and security context setup. The client device 822 in FIG. 8 is in such a scenario when it leaves cell 7 and enters cell 12. The tracking area update (TAU) for the client device 822 may trigger a deregistration and a new connection setup with a new security context. Therefore, a false network access node (e.g., the false network access node 802 in cell 99) may exploit this behavior of the 3GPP protocol with respect to a TAU procedure and may trigger EMM deregistration, forcing the client device to connect to the false network access node, which is potentially the situation that client device 826 is in.

A false network access node (e.g., false network access node 802 in FIG. 8) may exploit the TAU procedure by forcing the release of the RRC connection between a client device and the communication network (e.g., an LTE network) and breaking down the security context, thereby requiring re-establishment of the RRC connection and setup of a new security context. In this scenario, the false network access node may force the victim client device to connect to it. The TAC for a false network access node must be different than all the TACs in the geographical area of its operation (a false network access node may never be connected to the core network). The TAC for the false network access node may be an invalid number, or may be a valid number that would be a TAC of a relatively distant network access node. For example, with reference to FIG. 8, when the client device 826 enters cell 99 having a TAC (e.g., TAC 44) that is not within the TAI list (which includes TAC 1) of the client device 826, the client device 826 may be tricked into performing a TAU procedure (e.g., sending a TAU request message). In one scenario, the client device 826 may release its RRC connection and may abandon its security context (e.g., due to a TAU reject message from the false network access node 802), thereby requiring re-establishment of the RRC connection and setup of a new security context. In such a scenario, the client device 826 may be forced to connect to the false network access node 802. The false network access node 802 may perform an Identity Request type 1 to obtain the IMSI of the client device 826. Once the IMSI is obtained, the false network access node 802 may either send an Attach Reject or may simply stop sending messages all together.

### Enhanced Geographical Whitelist Database of Network Access Nodes

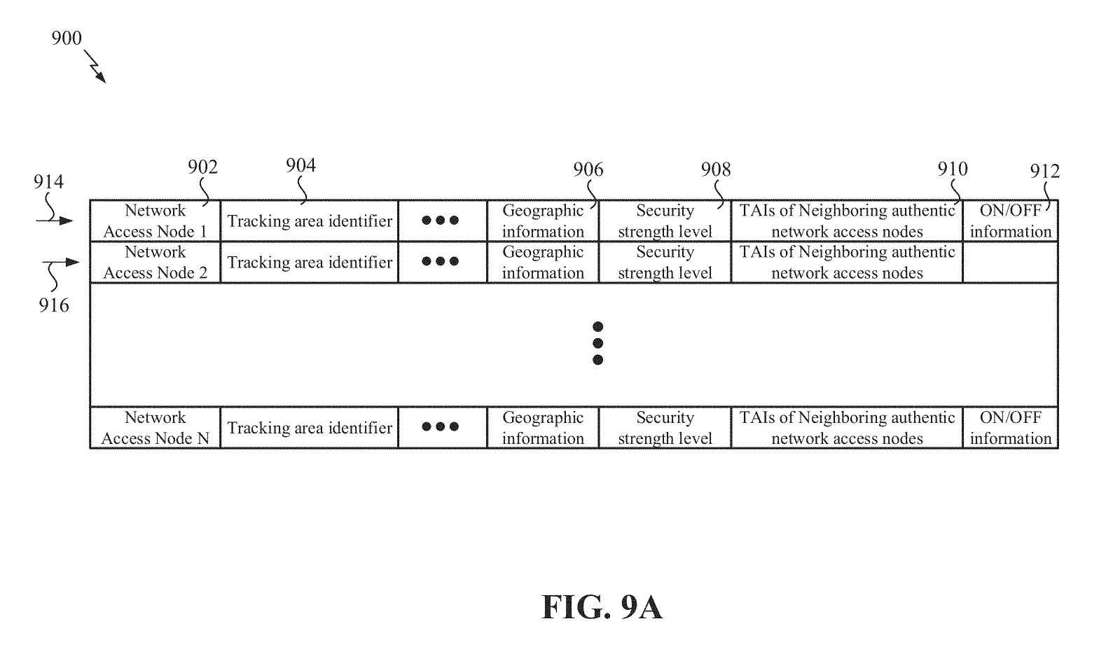

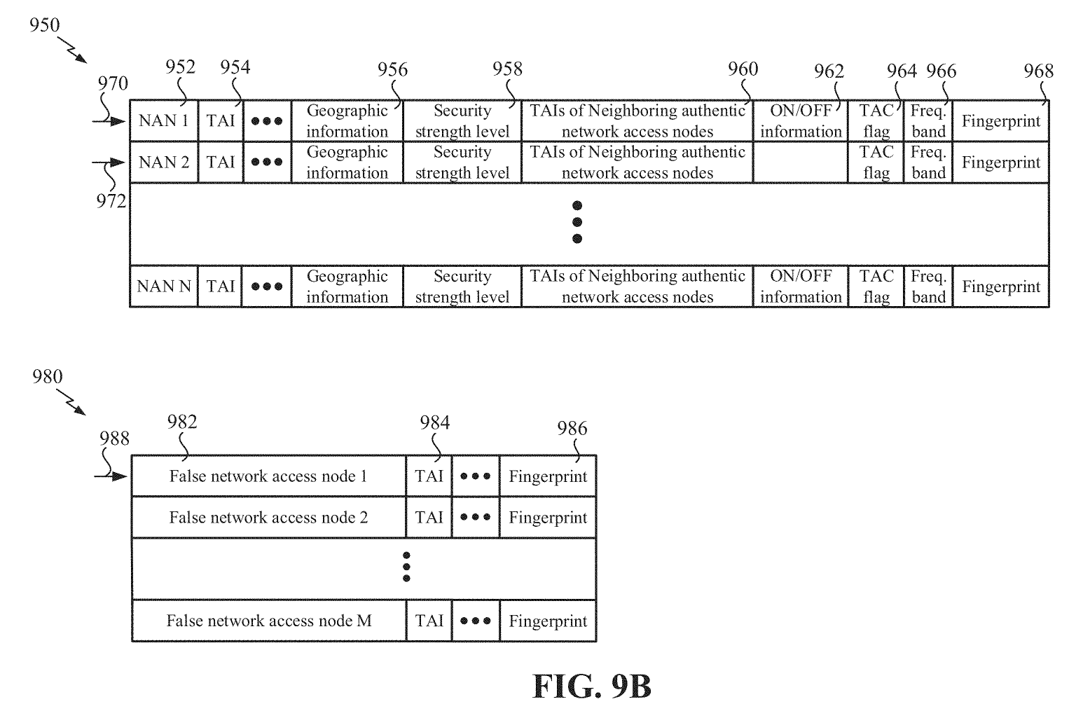

The geographical whitelist database of network access nodes (also referred to as a geographical whitelist database or network access node list) may include a number of entries, where each entry includes multiple fields. FIG. 9A illustrates a first example geographical whitelist database of network access nodes 900 in accordance with some aspects of the present disclosure. For example, each entry (e.g., entry 914) may include a first field 902 indicating an authentic network access node in the communication network (e.g., an LTE network), a second field 904 indicating a tracking area identifier of that authentic network access node, and a third field 906 indicating geographic information for that authentic network access node. In some aspects of the disclosure, each entry in the geographical whitelist database may further include a fourth field 908 indicating a security strength level of the configuration and/or system setting of the authentic network access node against being faked, forged, and/or attacked by an unauthorized (e.g., malicious) user. In other words, the fourth field 908 may indicate a measure of difficulty for a false network access node to simulate or mimic the authentic network access node. This information in the fourth field 908 may be used by a false network access node detection algorithm running on the client device to obtain a confidence level of the detection result. For example, the higher the value of the fourth field 908 in the geographical whitelist database (e.g., indicating a stronger configuration and/or system setting and, therefore, indicating that the authentic network access node is more difficult to fake), the easier it may be for the false network access node detection algorithm to reduce false positives. This is because if the client device observes a network access node with a configuration and/or system setting similar to the authentic network access node indicated in the geographical whitelist database, then it may be highly likely that the observed network access node is that authentic network access node. If the value for the fourth field 908 is low (e.g., indicating a weaker configuration and/or system setting and, therefore, indicating that the authentic network access node is easier to fake), the easier it may be for the detection algorithm to more accurately identify a false network access node. This is because if the client device observes a network access node with a configuration and/or system setting similar to the authentic network access node indicated in the geographical whitelist database, then there is a higher probability that the observed network access node may be a false network access node (e.g., the observed network access node is not an authentic network access node).

In some aspects of the disclosure, each entry in the geographical whitelist database of network access nodes 900 may further include a fifth field 910 indicating information (also referred to as network cell transition information) about the geographically neighboring authentic network access nodes (e.g., relative to the authentic network access node corresponding to the entry) having a different tracking area identifier (TAI) with respect to the authentic network access node corresponding to the entry. For example, the fifth field 910 may be used for authentic network access nodes that are located at a border of a TAI cell group, hence with TAI values different than the current cell in question. A TAI may include a Public Land Mobile Network identifier (PLMN ID) and a Tracking Area Code (TAC) that corresponds to a tracking area (TA). In some aspects, the same operator, country, and TAC may correspond to the same TAI. In some aspects of the disclosure, the information in the fifth field 910 about the geographical whitelist database having a different TAI may help a client device to speculatively prefetch a new TAI list and the network access node information of a completely new TAI group that the client device might be traveling into. Therefore, the prefetched new TAI list may enable the false network access node detection algorithm running on the client device to be ready with the whitelist database of the neighboring network access nodes in the new TAI list prior to moving into the new TAI group. Since there may be multiple neighboring cells with different TAI values, the fifth field 910 may contain a vector of different TAI values. In some aspects of the disclosure, the fifth field 910 may include a single instance of each unique TAI value (e.g., the same TAI is not repeated in the fifth field 910), despite the fact that there may be multiple neighboring cells with the same TAI.

In some aspects of the disclosure, directional information of the neighboring cells with the different TAI values may also be included in the fifth field 910. For example, the directional information may indicate if the cells with the specific TAI values are situated in a particular direction (e.g., North, South, East, West, North-East, North-West, South-East, South-West) of the current cell. This allows more accuracy when a client device is moving and entering into the new TAI's network cell as the direction of motion of the client device may be compared with the directional position for the possible new TAI of the neighboring network cell the client device will enter into. This further helps to close the attack window of any false network access nodes.

In some aspects of the disclosure, each entry in a geographical whitelist database may correspond to a cell being served by an authentic network access node (e.g., the first field 902 in FIG. 9A may indicate a valid cell being served by an authentic network access node in the communication network (e.g., an LTE network)). Referring back to FIG. 8, an example entry for cell 9 in a geographical whitelist database may include the previously described fifth field 910 that contains the TAI values (e.g., where each TAI value may include a PLMN ID and a TAC) of any neighbor cells adjacent to cell 9 and which have TAI values that are different from the TAI value of cell 9. Accordingly, the fifth field 910 in the example entry for cell 9 may include the TAI value of cell 3, the TAI value of cell 4, and the TAI value of cell 5. As additional examples, the fifth field 910 in an example entry for cell 6 may include the TAI value of cell 1 and the TAI value of cell 3, the fifth field 910 in an example entry for cell 5 may include the TAI value of cell 9 and the TAI value of cell 11, and the fifth field 910 in an example entry for cell 8 may include the TAI value of cell 3 and the TAI value of cell 12. In some aspects of the disclosure, the fifth field 910 may include a single instance of a particular TAI value. In such aspects, for example, the fifth field 910 in the example entry for cell 9 may include the TAI value TA 1, since cells 3-5 all have the same TAI value. As another example, the fifth field 910 in the example entry for cell 6 may include the TAI value TA 1, since cells 1 and 3 both have the same TAI value. However, the fifth field 910 in the example entry for cell 8 may include the TAI value TA 1 and the TAI value TA 3, since cell 3 and cell 12 have different TAI values. Therefore, the fifth field 910 indicating geographically neighboring authentic network access nodes (e.g., relative to the authentic network access node corresponding to the entry) having different TAI values may include a vector of values. For example, directional information (e.g., North, South, East, West, North-East, North-West, South-East, South-West) of the neighboring cells with the different TAI values may also be included in the fifth field 910.

FIG. 8 also illustrates how the presence of an example fake cell 99 (e.g., served by the false network access node 802) with TAC and TAI values of 44 can be easily recognized with the information in the fifth field 910 described with reference to FIG 9A. For example, the client device 826 (also referred to as UE 3 in FIG. 8) may obtain a geographical whitelist database of the authentic network access nodes (e.g., the geographical whitelist database of network access nodes 900) from the authentic cell 4 before the client device 826 is lured (e.g., attacked) by the fake cell 99. As such, information (e.g., in the fifth field 910) in the obtained geographical whitelist database may indicate to the client device 826 any TAI values of neighboring cells that are different from the TAI value of the current cell (e.g., the currently connected cell 4). Accordingly, since the only neighboring authentic cell (with respect to the current cell 4) with a different TAI value is cell 9 having TAI value TA 2, the client device 826 would know that the only valid TAI value in a neighboring cell (that has a different TAI value) may be the TAI value TA 2. Since the TAI values of the other authentic neighboring cells 3 and 5 are the same as the TAI value of the current cell 4, such same TAI values will not cause a TAU procedure and are not maintained. Therefore, when the client device 826 observes a TAI value of 44 (e.g., the TAI value of the fake cell 99), the client device 826 may immediately detect the fake cell 99 and raise an alarm. Therefore, for example, when the client device 826 is in cell 4 and the tracking area identifier of neighboring cell 9 is excluded from the TAI list of the client device 826, the information (e.g., in the fifth field 910) in the geographical whitelist database may notify the client device 826 to expect to perform a TAU procedure when entering the tracking area of neighboring cell 9. Since the client device 826 has knowledge of the tracking area identifier of neighboring cell 9 (e.g., TA 2) from the geographical whitelist database prior to entering cell 9, the client device 826 may detect that the observed network access node 802 (e.g., of cell 99 in FIG. 8) with an unexpected tracking area identifier (e.g., TA 44) is highly likely to be a false network access node.

The directional information (which may also be included in the fifth field 910) associated with neighboring TAI values may indicate a direction toward cell 9 (e.g., the only neighboring cell with a different TAI value), such as the South-East direction. This directional information further helps confirm that when the client device 826 is moving in a South-East direction from the current cell 4, a TAU procedure with the new TAI value TA 2 is expected. For example, the client device 826 may use any device capabilities or means, such as magnetometer sensors and/or connectivity capabilities (e.g., GPS), to determine its own direction of movement. The associated directional information of the neighboring cell with a different TAI allows for better confidence in false network access node detection for a moving client device.

### Logic for Prefetching From Network Cloud Database and Caching On-Device

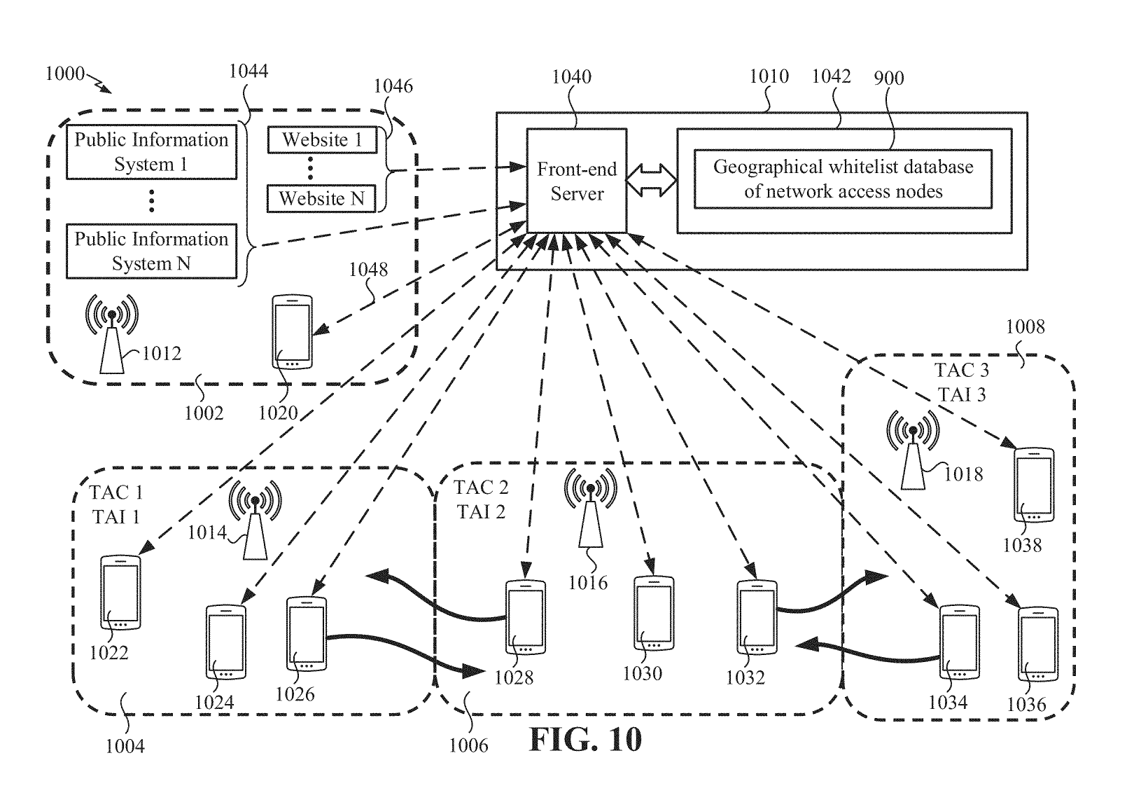

In some aspects described herein, the geographical whitelist database of network access nodes (e.g., the example geographical whitelist database of network access nodes 900 in FIG. 9A or the example geographical whitelist database of network access nodes 950 in FIG. 9B) may be stored in a network cloud database (as described in detail herein with respect to FIG. 10), and a client device (e.g., the client device 300) may obtain at least one portion of the geographical whitelist database from the network cloud database. In some aspects of the disclosure, a client device may prefetch one or more items of a geographical whitelist database prior to being powered OFF or prior to entering a low power mode or disconnected mode (e.g., airplane mode) that disables the communication interface (e.g., transceiver) of the client device. In such aspects, before the client device is powered OFF or placed in the previously described low power mode or disconnected mode, the client device may prefetch and store a geographical whitelist database (or at least one portion of the geographical whitelist database) for a new geographical location where the client device is expected to be powered ON or where the client device is expected to be switched from the low power mode to a normal power mode (e.g., a mode where the communication interface is no longer disabled). For example, the prefetched portion of the geographical whitelist database may be stored in a memory (e.g., a local device cache) of the client device. Since the client device has stored the geographical whitelist database for the geographical location where the client device is expected to be powered ON, or where the client device is expected to be switched from the low power mode to a normal power mode, the client device will already have the geographical whitelist database during the vulnerable window when switching from an idle state to a connected mode in the new geographical location. With a precise location specific whitelist of authentic network access nodes already cached on-device, the client device will be less likely to obtain a tampered or malicious database in the new geographic location and/or less likely to connect to a false network access node in the initial connection setup, since it can refer to the whitelist of authentic network access nodes during the initial connection setup. It should be noted that this mechanisms may break a deadlock situation where there is a need for a geographical whitelist database of authentic network access nodes for the new location, but there is no connectivity of any form to obtain the geographical whitelist database of authentic network access nodes from the network (e.g., cloud). Thus, the previously described predictive prefetching with accurate geographical information of the future possible location of the client device may substantially increase the ability of the false network access node detection algorithm running on the client device to accurately detect any false network access nodes that may be deployed in the new geographic location. In some scenarios, a client device may be powered ON in the same geographical location where the client device was powered OFF (or where the client device entered a low power mode). In these scenarios, it should be noted that the client device may have a geographical whitelist database for its current geographical location stored in a memory of the client device prior to being powered OFF. Since the client device may recover the geographical whitelist database for this geographical location (e.g., from the memory) when the client device is powered ON in this same geographical location, this scenario may be automatically handled by the client device. Accordingly, in some aspects of the disclosure, the client device may be configured to prevent discarding of a geographical whitelist database for its current geographical location prior to being powered OFF (or prior to entering a low power mode).

In one aspect of the disclosure, prior to powering OFF the client device or prior to placing the client device in the previously described low power mode (e.g., airplane mode), the user of the client device may be prompted by an application program of the client device to enter destination information (e.g., country, city, town, village, and/or zip code) regarding a new geographic location where the client device is expected to be powered ON, or where the client device is expected to be switched from the low power mode to a normal power mode. The client device may then prefetch the geographical whitelist database (or one or more items of information from the geographical whitelist database) for network access nodes in and/or around the new geographical location (e.g., in and/or around the geographic coordinates corresponding to the destination information). In one aspect of the disclosure, the one or more items of information from the geographical whitelist database may include the TAI of network access nodes (e.g., from the second field 904) in and/or around the geographic coordinates corresponding to the destination information.

In one example scenario, the client device may prefetch one or more items of information (e.g., TAIs) from geographical whitelist databases available for each possible destination from the current location (e.g., an airport, train station, bus terminal) of the client device. For example, if the current location of the client device is an airport, the client device may obtain all possible flight destinations from the airport and may prefetch the TAIs from the geographical whitelist databases of the possible flight destinations. In such example, the client device may continue to prefetch one or more items of information (e.g., TAIs) from geographical whitelist databases for network access nodes that are located in and around the destination airport coordinates. In one aspect, the client device may prefetch one or more items of information from geographical whitelist databases for network access nodes that are located within a radius (e.g., a 5 miles) of the destination airport. In one scenario, if the number of different destinations is substantial (e.g., there are too many items of information from geographical whitelist databases for the client device to obtain and/or store), the client device may prefetch one or more items of information from geographical whitelist databases with respect to flights departing within a threshold period of time (e.g., 30 minutes, 60 minutes). This approach may be sufficient in such a scenario since the user would typically power OFF a client device or place the client device in a low power mode (e.g., airplane mode) shortly before the departure time of the flight. This is prefetching for a sliding window of time, and the cached/prefetched items of information from geographical whitelist databases for those destinations for which all flights have already departed (and where there are no other flights departing for those destinations within a threshold period of time (e.g., 2 hours, 3 hours)) may be removed from the cache of the client device.

When one or more items of information (e.g., TAIs) from geographical whitelist databases are to be fetched for a large number of destinations (e.g., a threshold number of destinations), the false network access node detection algorithm running on the client deice may decide to prefetch the TAIs and/or some minimal information that may be required by the algorithm to safely and reliably detect false network access nodes when the client device is powered ON (or switched from the low power mode to a normal power mode) upon reaching the destination.

In some aspects of the disclosure, when a client device continuously remains powered ON (or when the client device does not enter the low power mode (e.g., airplane mode)), the client device may maintain a sliding window in which one or more items of information from geographical whitelist databases are cached. In such aspects, the client device may prefetch one or more items of information from geographical whitelist databases as the client device continues to move. For example, the client device may obtain the direction and the speed of the client device when the client device is moving (e.g., major highways), and may adjust the sliding window based on the direction and the speed of the client device. In some aspects of the disclosure, the client device may not clear the cache for the geographical locations most frequently visited by the client device.

In some aspects of the disclosure, each entry in the geographical whitelist database may further include a sixth field 912 indicating a correlation of future power ON/OFF switching possibilities for a network access node seen to operate in a temporary and either periodic or aperiodic ON/OFF manner. It is to be noted that the ON/OFF switching possibilities may be aperiodic in nature, such that a network access node may be ON or OFF at different times of the day, or ON or OFF on different days of the week in the immediate future. Therefore, the sixth field 912 may be updated by a network device (e.g., network device 400 and/or network device 1010) as new information about the possible future ON/OFF switching of a network access node is determined. In some aspects of the disclosure, the ON/OFF switching information may be maintained only with respect to a window of time in the immediate future for which the ON/OFF timing may be reliably determined. Since the ON/OFF switching information may be aperiodic for a window of time in the immediate future, the data structure for the stored information may be a vector of time values listing the potential ON and OFF times.

In some aspects of the disclosure, the correlation of power ON/OFF switching possibilities may be obtained based on publicly available information of event times and may be stored in the sixth field 912 (e.g., as metadata). It should be understood that the use of such sixth field 912 is optional and may not include any information for a network access node (e.g., the entry 916 for Network Access Node 2) that persistently remains ON (e.g., a network access node that is always available). In some aspects of the disclosure, the sixth field 912 may include a pointer/index for the actual metadata. For example, the actual metadata may include an elaborate description of the behavior of the corresponding network access node detailing the possible ON/OFF switching times over a period of time or may include information enabling the client device to determine if the corresponding network access node should be ON or OFF at the current time. In some aspects of the disclosure, since the ON/OFF switching times may be determined using various crowdsourced information, there may be a corresponding confidence value attached to each determined ON/OFF switching time value. The false network access node detection algorithm running on the client device may use both the ON/OFF switching time values and the associated confidence values to determine the detection result or a risk score. The false network access node detection algorithm running on the client device as described herein may obtain such risk score for the network access node based on a total of one or more constant risk point values (or one or more adjusted risk point values) assigned to specific network events observed by a client device. In some aspects, the risk score indicates a probability that the network access node is a false network access node. For example, a client device may determine that a network access node is a false network access node when the risk score for the network access node exceeds a threshold. In some aspects of the disclosure, a risk score may be maintained for one or more cells of a network access node.

In some aspects of the disclosure, ON/OFF switching time information that corresponds to a time period that has already passed may be removed from the contents of the sixth field 912 as this information may no longer be relevant. In some aspects of the disclosure, new information about the future ON/OFF switching behavior of an authentic network access node may be computer determined (e.g., at the network device 400) by gathering information from various public information systems, public event websites, etc. A network device may be implemented with the cloud data base to crowdsource information for computing the future possible ON/OFF switching times.

In some aspects of the disclosure, a network device (e.g., network device 400 and/or network device 1010) may gather information from public information systems (e.g., websites) about notable events (e.g., events involving large gatherings of people) that have been publicized or advertised. For example, a network device may obtain venues and corresponding times for the notable events, and may identify any network access nodes matching such venues and corresponding times.

In some scenarios, a network access node at a fixed location may be intermittently used (e.g., the network access node is turned ON for a notable event, such a sporting event at a stadium or a performance at a concert hall, but is turned OFF after the conclusion of the event). For example, such intermittently used network access nodes may be pico network access nodes or femto network access nodes. In these scenarios, a network device may determine the ON/OFF pattern or behavior of these network access nodes at fixed locations based on the matching venues and timing of the previously described notable events. Accordingly, in some aspects of the disclosure, the sixth field 912 may include actual metadata (or a pointer/index for the actual metadata) that indicates the determined ON/OFF pattern or behavior of these network access nodes at fixed locations. For example, the sixth field 912 may indicate that the predicted behavior of the corresponding network access node is that the network access node normally remains powered OFF except during the times of the notable events. In another example, the sixth field 912 may indicate that the corresponding network access node has a particular periodic ON/OFF pattern (e.g., the network access node is powered ON during a particular event that occurs at the same time every year, but is otherwise powered OFF). Therefore, it can be appreciated that such information included in the previously described sixth field 912 may enable a client device to accurately predict the availability of the intermittently used network access nodes for the immediate future.

FIG. 9B illustrates a second example geographical whitelist database of network access nodes 950 and an example blacklist of false network access nodes 980 in accordance with some aspects of the present disclosure. For example, each entry (e.g., entry 970, entry 972) may include a first field 952 indicating an authentic network access node (abbreviated as NAN in FIG. 9B) in the communication network (e.g., an LTE network) and a second field 954 indicating a tracking area identifier (abbreviated as TAI in FIG. 9B) of that authentic network access node. In some aspects of the disclosure, the second field 954 may include one or more time durations (also referred to as time ranges) and one or more corresponding TACs. Such aspects may apply in scenarios when a network operator is performing load balancing with respect to a network access node and the TAC assigned to that network access node is changed during some time durations to achieve the load balancing. Accordingly, it should be noted that the TAC of the cells served by that network access node may change during some time durations. In some aspects of the disclosure, the second field 954 may indicate different time durations that are portions of a repeatable period or cycle and one or more corresponding TACs. For example, such repeatable periods may include a day, a week, a specific number of successive days, etc. In one example, if the repeatable period is a day (e.g., a 24 hours), the different time durations may cover mornings and evenings. In another example, if the repeatable period is a week, the different time durations may cover mornings and evenings on weekdays, and mornings and evenings on weekends. For example, the TAC assigned to a network access node may be TAC 1 during weekday mornings (e.g., 6 am to 10 am) and may change to TAC 2 during weekday afternoons (e.g., 12 pm to 6 pm). In this example, the TAC assigned to that network access node during the weekend (e.g., 24 hours on Saturdays and Sundays) may be TAC 2. In this example, the second field 954 may include three different items of information (e.g., for the three different time durations) covering a weekly periodicity. Accordingly, the first of the three items may indicate TAC 2 for 6 am to 10 am on a weekday, the second of the three items may indicate TAC 1 for 12 pm to 6 pm on a weekday, and the third of the three items may indicate TAC 2 for Saturday and Sunday.

In some aspects of the disclosure, each entry in the geographical whitelist database may further include a third field 956 indicating geographic information for that authentic network access node and a fourth field 958 indicating a security strength level of the configuration and/or system setting of the authentic network access node against being faked, forged, and/or attacked by an unauthorized (e.g., malicious) user. For example, the third field 956 may include information similar to the previously described third field 906 indicating geographic information for that authentic network access node, and the fourth field 958 may include information similar to the previously described fourth field 908 indicating a security strength level of the configuration and/or system setting of the authentic network access node against being faked, forged, and/or attacked by an unauthorized (e.g., malicious) user. In some aspects of the disclosure, each entry in the geographical whitelist database may further include a fifth field 960 indicating information (also referred to as network cell transition information) about the geographically neighboring authentic network access nodes (e.g., relative to the authentic network access node corresponding to the entry, such as the entry 970) having a different TAI with respect to the authentic network access node corresponding to the entry. In some aspects of the disclosure, the fifth field 960 may include one or more time durations (also referred to as time ranges) and one or more corresponding TACs of neighboring authentic network access nodes. Such aspects may apply in scenarios when a network operator is performing load balancing with respect to a neighboring authentic network access node and the TAC assigned to that neighboring authentic network access node is changed during some time durations to achieve the load balancing. In some aspects of the disclosure, the fifth field 960 may indicate different time durations that are portions of a repeatable period or cycle and one or more corresponding TACs in a format similar to the previously described second field 954. Therefore, in some aspects of the disclosure, the fifth field 960 may include one or more time durations and corresponding TACs, such that the TACs included in the fifth field 960 are different from the TACs in the second field 954 during the same or overlapping time durations. For example, as previously described, the second field 954 of the entry 970 may include three different items of information for a network access node, where the first of the three items may indicate TAC 2 for 6 am to 10 am on a weekday, the second of the three items may indicate TAC 1 for 12 pm to 6 pm on a weekday, and the third of the three items may indicate TAC 2 for Saturday and Sunday. In this example, since the TAC assigned to the network access node corresponding to entry 970 is TAC 1 during 12 pm to 6 pm on weekdays, the fifth field 960 may include an item of information for a neighboring authentic network access node that indicates TAC 2 for 12 pm to 6 pm on weekdays. In another example, if the neighboring authentic network access node is assigned to TAC 1 for 12 pm to 6 pm on weekdays, the fifth field 960 may not indicate this information since the network access node corresponding to entry 970 is also assigned TAC 1 during 12 pm to 6 pm on weekdays. In some aspects of the disclosure, each entry in the geographical whitelist database may further include a sixth field 962 indicating a correlation of future power ON/OFF switching possibilities for a network access node seen to operate in a temporary and either periodic or aperiodic ON/OFF manner For example, the sixth field 962 may include information similar to the previously described sixth field 912.

In some aspects of the disclosure, each entry in the geographical whitelist database may further include a seventh field 964 indicating a TAC flag (also referred to as a mutable flag) for a network access node. For example, when the TAC flag is enabled (e.g., when the seventh field 964 includes the value ‘1’), the TAC flag may indicate that the tracking area code assigned to the network access node (e.g., the network access node 1 corresponding to entry 970) may change in a periodic and/or predictable manner due to load balancing performed by the operator of the network access node. In some aspects of the disclosure, the network may obtain information (e.g., information crowdsourced from one or more client devices) to determine whether to enable or disable the TAC flag for a network access node. For example, the network may disable the TAC flag for the network access node by including the value ‘0’ in the seventh field 964. For example, if the network obtains information from one or more client devices indicating that a network access node is operating with different TACs at different times, the network may determine that the network access node has a TAC that may change. Accordingly, the network may enable the TAC flag (e.g., the seventh field 964) for a network access node in the geographical whitelist database. In some aspects of the disclosure, the different time durations indicated in the second field 954 may be based on information obtained (e.g., crowdsourced information) from the one or more client devices. For example, the network may observe information reported by one or more client devices as to the TAC assigned to a network access node at different times. The network may then determine one or more time durations and corresponding one or more TACs from the reported information. In some aspects of the disclosure, the network may determine multiple time durations that covers a repeatable period (e.g., a day, a week, etc.) or cycle from the information reported by the one or more client devices.

In some aspects of the disclosure, each entry in the geographical whitelist database may further include an eighth field 966 indicating one or more frequency bands an operator may be using for the network access node. For example, the one or more frequency bands may be based on the jurisdiction in which the network access node is located and the operator. In some aspects of the disclosure, the one or more frequency bands indicated for a network access node in the eighth field 966 may be obtained through crowdsourcing. For example, after performing a successful mutual authentication procedure (e.g., an Authentication and Key Agreement (AKA) procedure) with a network access node, a client device may provide one or more frequencies used by the network access node to the network. In some aspects of the disclosure, the false network access node detection algorithm running on the client deice may obtain the one or more frequencies and the PLMN from system information block 1 (SIB1). Therefore, since a network access node may be using different frequencies in a band at different times, one or more client devices may report the different frequencies used by that network access node to the network. Accordingly, the network may update the geographical whitelist database to include the different frequencies for that network access node. In some aspects, the network may determine a frequency band (e.g., the highest and the lowest frequencies from the different frequencies reported by the client devices) and include the frequency band in the eighth field 966. In some aspects of the disclosure, if the one or more frequency bands indicated in the eight field 966 does not match or at least partially overlap the one or more frequencies of the network access node detected by the client device, the client device may detect that a network access node of a network cell (e.g., a network access node that the client device observes as advertising itself as a cell in an attempt to lure the client device) is a false network access node.

In some aspects of the disclosure, each entry in the geographical whitelist database may further include a ninth field 968 that indicates a fingerprint associated with a network access node. In such aspects, the client device may use the fingerprint to identify a network access node observed in the network. For example, the fingerprint may be a value (e.g., a code, a number, an alphanumeric string, etc.) that is unique to a network access node. In some aspects of the disclosure, the fingerprint may be a radiometric fingerprint or may be a combination of hardware and signal characteristics that the client device may use to identify a network access node. It should be understood that in such aspects, the fingerprint may not be spoofed by a false network access node in an attempt to lure a client device to connect to it. In cases where the client device is able to determine the fingerprint of an observed network access node that it has camped on or connected to, the client device may determine whether such observed network access node is a false network access node by comparing the determined fingerprint to the fingerprint in the geographical whitelist database (e.g., in the ninth field 968 as previously described). If the determined fingerprint does not match any of the fingerprints in the geographical whitelist database, the client device may determine that the observed network access node is a false network access node.

In some aspects of the disclosure, the client device may obtain a blacklist of false network access nodes (e.g., the blacklist of false network access nodes 980) that identifies known false network access nodes and/or suspected false network access nodes. In such aspects of the disclosure, each entry (e.g., entry 988) may include a first field 982 indicating a false network access node and a second field 984 indicating a tracking area identifier (abbreviated as TAI in FIG. 9B) associated with that false network access node. In some aspects of the disclosure, each entry (e.g., entry 988) for a false network access node may include a third field 986 indicating a fingerprint for that false network access node. For example, and as previously described, the fingerprint may be a value (e.g., a code, a number, an alphanumeric string, etc.) that is unique to the false network access node. It should be understood that the fingerprint may not be spoofed by a false network access node in an attempt to lure a client device to connect to it. In cases where the client device is able to determine the fingerprint of an observed network access node, the client device may determine whether such observed network access node is a false network access node by comparing the determined fingerprint to a fingerprint in the blacklist of false network access nodes 980. If the determined fingerprint matches any of the fingerprints included in the blacklist of false network access nodes 980, the client device may determine that the observed network access node is a false network access node. Therefore, in some scenarios, the client device may use the fingerprints included in the blacklist of false network access nodes 980 to efficiently identify an observed network access node as a false network access node (e.g., even when the observed network access node identified as a false network access node has moved to a different location and is observed at a different time) by performing a comparison operation. In some aspects of the disclosure, the network may generate the blacklist of false network access nodes 980 and may provide the blacklist of false network access nodes 980 to the client device. In other aspects of the disclosure, the client device may be preconfigured with the blacklist of false network access nodes 980.

In some aspects of the disclosure, the network may consider a network access node to be a false network access node (e.g., for purposes of including such network access node in the blacklist) when one or more client devices detects a failure during mutual authentication with respect to a network access node and/or when one or more client devices assesses a threat score that exceeds a threshold for the network access node (e.g., using the false network access node detection algorithm running on the client deice). In some aspects of the disclosure, the client device may determine the fingerprint of an observed network access node and may upload the determined fingerprint to the network. In some aspects of the disclosure, the client device may upload the fingerprint of a network access node along with one or more other items of information that may be crowdsourced by the network, such as a threat score for the observed network access node. In some aspects of the disclosure, a fingerprint of a network access node may be determined based on immutable features in system parameters, hardware features, and/or signal properties of a network access node.

In some aspects of the disclosure, the network may generate a geographical network access node database that includes a list of both whitelisted and blacklisted network access nodes, where the geographical network access node database includes a fingerprint for each of the whitelisted and blacklisted network access nodes. In such aspects, the client device may determine a fingerprint for a network access node observed in a network and may compare the fingerprint to the fingerprints in the geographical network access node database. If the determined fingerprint matches a fingerprint of a blacklisted network access node in the geographical network access node database, the client device may determine that the observed network access node is a false network access node.

In some aspects of the disclosure, a client device may provide one or more of the previously described crowdsourced information (e.g., information indicating that a network access node is operating with different TACs at different times) to the network after successfully performing a mutual authentication procedure (e.g., an AKA procedure) with the network. In such aspects, the client device may not provide the one or more of the previously described crowdsourced information to the network if such mutual authentication procedure has not been performed or if such mutual authentication procedure has failed.

In some aspects of the disclosure, the previously described false network access node detection algorithm running on the client device may be configured to use various types of information, such as system information (e.g., Cell ID, location area code(LAC)/TAC, Evolved UTRA Absolute Radio Frequency Channel Number (EARFCN)) of a network access node observed by the client device, the protocol interaction and activities (e.g., ID request, RRC Reject, TAC Reject) between the client device and the observed network access node, and/or the contextual and environmental information in which the client device is operating when the activities are observed, to dynamically scale up or down a threat score for the observed network access node. This approach may enable the false network access node detection algorithm to accurately detect false network access nodes, while lowering incidences of false positives. In some aspects of the disclosure, the previously described contextual and environmental information may include a geographical distance gap between a serving cell and a tracking area identifier of an observed cell, the frequency of particular types of protocol activities and the context in which they are observed by the client device, a comparison of Licensed Band Policies of the jurisdiction in which a network access node is observed, discrepancies between the cell reselection parameters of an observed network access node and cell reselection parameters generally found in the neighboring network access nodes, and/or correlations between changes in signals received at the client device (e.g., a reduction in received signal strength) and possible environmental factors.

FIG. 10 illustrates an example network configuration 1000 for obtaining information for a geographical whitelist database of network access nodes in accordance with various aspects of the disclosure. As shown in FIG. 10, the example network configuration 1000 includes network cells 1002, 1004, 1006, and 1008, which are served by respective network access nodes 1012, 1014, 1016, and 1018. As further shown in FIG. 10, the network cell 1002 may include a client device 1020, the network cell 1004 may include client devices 1022, 1024, and 1026, the network cell 1006 may include client devices 1028, 1030, and 1032, and the network cell 1008 may include client devices 1034, 1036, and 1038. The network device 1010 may include a front-end server 1040 coupled to a database storage device 1042. In some aspects of the disclosure, the network device 1010 corresponds to the network device 400 in FIG. 4. For example, the database storage device 1042 may include the geographical whitelist database of network access nodes 900 and/or 950 previously described with reference to FIGS. 9A and 9B. In some aspects of the disclosure, the network device 1010 may include multiple geographical whitelist databases of network access nodes corresponding to different geographical regions.

In FIG. 10, each client device may establish a connection (e.g., a bi-directional connection indicated with dashed lines in FIG. 10, such as the bi-directional connection 1048) to the front-end server 1040 via a network access node. For example, the front-end server 1040 may be a cloud based server. In some aspects of the disclosure, one or more of the client devices in FIG. 10 may report (e.g., upload) information about new TACs they are entering into and information (e.g., a risk score) indicating whether the false network access node detection algorithm running on the client device has determined such new TACs to be safe. Such reporting of information by the client devices may be referred to as crowdsourcing. In some aspects of the disclosure, the front-end server 1040 may consolidate a number of risk scores reported from multiple client devices into a single risk score. In an aspect of the disclosure, the front-end server 1040 may fill the fourth field 908 and/or the fourth field 958 in an entry corresponding to a network access node with the consolidated single risk score. For example, the front-end server 1040 may obtain the consolidated single risk score by obtaining an average of the number of risk scores reported from multiple client devices. In some aspects of the disclosure, one or more of the client devices may obtain existing cloud-based information by querying the front-end server 1040. The front-end server 1040 may transmit at least one portion of the geographic whitelist database to at least one client device.

In one example, the network access nodes 1014, 1016, and 1018 may be permanent network access nodes with different TAC and TAI values, for which entries in the fifth field 910 of the geographical whitelist database of network access nodes 900 (or the fifth field 960 of the geographical whitelist database of network access nodes 950) are to be filled. In FIG. 10, the client device 1020 may be connected to the network access node 1012, client devices 1022, 1024, and 1026 may be connected to the network access node 1014, the client devices 1028, 1030, and 1032 may be connected to the network access node 1016, and the client devices 1034, 1036, and 1038 may be connected to the network access node 1018. In the example configuration of FIG. 10, the network cell 1004 has a TAC value of 1 and a TAI value of 1, the network cell 1006 has a TAC value of 2 and a TAI value of 2, and the network cell 1008 has a TAC value of 3 and a TAI value of 3. Therefore, it should be noted that the network cells 1004, 1006, and 1008 have different TAC and TAI values. As shown in FIG. 10, the client device 1026 is leaving the network cell 1004 and entering the network cell 1006, the client device 1028 is leaving the network cell 1006 and entering the network cell 1004, the client device 1032 is leaving the network cell 1006 and entering the network cell 1008, and the client device 1034 is leaving the network cell 1008 and entering the network cell 1006.

In some aspects of the disclosure, the client devices in FIG. 10 may be running a false network access node detection algorithm that obtains a risk score for each observed TAC value. Accordingly, the client devices may report the obtained risk scores for the TAC values to the front-end server 1040. For example, the client device 1026 may implement such false network access node detection algorithm to obtain risk scores associated with the network access node 1014 (e.g., the network cell 1004 having TAC value 1) and with the network access node 1016 (e.g., the network cell 1006 having TAC value 3), and may report the risk scores to the front-end server 1040. In some aspects of the disclosure, the front-end server 1040 may fill the fourth field 908 for one or more entries in the geographical whitelist database of network access nodes 900 by correlating and consolidating different risk scores that each client device has obtained for a network access node (or a network cell served by the network access node) while operating under that network access node's domain (e.g., while operating in the network cell served by that network access node).

In some aspects of the disclosure, each client device in FIG. 10 may report every new TAC value that the client device detects when the client device leaves one network cell and enters another network cell. For example, as client device 1026 leaves the network cell 1004 having a TAC value of 1 and enters the network cell 1006 having a TAC value of 2, the client device may detect the change in the TAC value and may report to the front-end server 1040 that a TAC value change has been detected when entering the network cell 1006 from the network cell 1004. In some aspects of the disclosure, the front-end server 1040 may use the previously discussed risk scores for the TAC values to determine whether a transition from a first network cell having a first TAC value to a second network cell having a second TAC value is likely to be a safe transition or a malicious transition. Therefore, risk scores obtained from multiple client devices as described above may strengthen the confidence that the values used to fill the fifth field 910 in corresponding entries are valid. For example, the front-end server 1040 may observe numerous risk scores obtained from multiple client devices to determine with reasonable confidence that a transition from one network cell to another network cell is safe, and accordingly may set the fifth field 910 with both the neighboring TAC value and directional information. For example, the directional information may indicate the direction in which the new network cell with that TAC is located with respect to the current network cell. The directional information may also be obtained from crowdsourced data, as the false network access node detection algorithm running on each client device moving between one network cell to another network cell may be configured to report the directional information to the front-end server 1040.

In the example network configuration 1000, the network access node 1012 may be a transient network access node. In some aspects of the disclosure, the front-end server 1040 may obtain the estimated future ON/OFF switching times of the network access node 1012 and may update the geographical whitelist database (e.g., the sixth field 912 of the entry 914 in the geographical whitelist database in a case where the network access node 1012 corresponds to the network access node 1 in FIG. 9A). The manner in which the front-end server 1040 may obtain the estimated future ON/OFF switching times of the network access node 1012 will now be discussed. As shown in FIG. 10, the front-end server 1040 may obtain information from one or more public information systems 1044 (e.g., public information system 1 to public information system N), and/or from one or more public websites 1046 (e.g., website 1 to website N). In some aspects of the disclosure, the one or more public information systems 1044 and the one or more public websites 1046 may obtain information regarding any future events (e.g., specific time information for the location covered by the transient network access node 1012), and may upload the information to the front-end server 1040. The front-end server 1040 may correlate all the information from the one or more public information systems 1044 and/or the one or more public websites 1046, and may obtain a vector of ON/OFF switching times and metadata for the sixth field 912 and/or the sixth field 962 for the transient network access node 1012.

In some aspects of the disclosure, the front-end server 1040 may obtain one or more tracking area codes assigned to a network access node at different time periods.

Accordingly, the front-end server 1040 may determine that the network access node uses the one or more tracking area codes at the different time periods based on the information. In such aspect, the front-end server 1040 may enable a tracking area code flag for the network access node in a geographical whitelist database (e.g., in the seventh field 964 of the geographical whitelist database 950), where the tracking area code flag is configured to indicate that a tracking area code of the network access node changes in a periodic and/or predictable manner In some aspects of the disclosure, the front-end server 1040 may determine one or more time durations and corresponding tracking area codes for a network access node. In such aspects, the front-end server 1040 may include the one or more time durations and the corresponding tracking area codes in a geographical whitelist database (e.g., in the second field 904 or the second field 954). In some aspects of the disclosure, the one or more time durations are portions of a repeatable period.

In some aspects of the disclosure, the front-end server 1040 may obtain one or more notifications from client devices that a mutual authentication procedure with a network access node has failed. In some aspects of the disclosure, the client devices in FIG. 10 may report the one or more frequencies an operator has used for a network access node to the front-end server 1040. Such aspects of the disclosure enable the front-end server 1040 to detect the one or more frequencies an operator has used for a network access node. For example, the front-end server 1040 may determine one or more frequency bands an operator may be using for the network access node of a network cell based on the one or more frequencies and may include the one or more frequency bands in the geographical whitelist database (e.g., in the eighth field 966 of the geographical whitelist database 950).

In some aspects of the disclosure, the front-end server 1040 may receive reports from one or more client devices that have detected a failure during mutual authentication with a network access node, and/or from one or more client devices that have assessed a threat score for a network access node that exceeds a threshold (e.g., using the false network access node detection algorithm running on the client deice). In such aspects, the front-end server 1040 may generate a blacklist of known or suspected false network access nodes (e.g., the blacklist of false network access nodes 980) based at least on the received reports. In some aspects of the disclosure, the front-end server 1040 may further include a TAI value and a fingerprint value (e.g., which may be provided from one or more client devices via crowdsourcing) for each of the false network access nodes in the blacklist of known or suspected false network access nodes.

In some aspects of the disclosure, the front-end server 1040 may store information provided by one or more client devices (or values that are based on information provided by one or more client devices) in a geographical whitelist database when such information is provided by one or more client devices that have successfully performed a mutual authentication procedure with at least one network access node. For example, the front-end server 1040 may discard crowdsourced information uploaded by client devices that have not successfully performed a mutual authentication procedure with at least one network access node.

Although FIG. 10 includes one network device 1010 for ease of illustration, it should be understood that multiple network devices 1010 may be implemented. Accordingly, in some aspects, such multiple network devices 1010 may be spread over geographically for load-balancing and for fast localized service, and the different database storage devices 1042 may be configured to synchronize one or more items of information (e.g., one or more fields of the geographical whitelist database of network access nodes) amongst themselves. In some aspects of the disclosure, due to geo-political reasons and/or local government policies, the network device 1010 may be decoupled, and may contain data specific to only an authorized political or geographical region.

FIG. 11 (including FIGS. 11A and 11B) is a flow chart illustrating an exemplary process 1100 in accordance with some aspects of the present disclosure. As described below, some or all illustrated features may be omitted in a particular implementation within the scope of the present disclosure, and some illustrated features may not be required for implementation of all embodiments. In some examples, the process 1100 may be carried out by the client device 300 illustrated in FIG. 3. In some examples, the process 1100 may be carried out by any suitable apparatus or means for carrying out the functions or algorithm described below. It should be understood that the blocks with dashed lines in FIG. 11 represent optional blocks.

With reference to FIG. 11A, at block 1102, the client device may obtain, in a first network cell, information from a network access node list, the information indicating a tracking area identifier of a second network cell neighboring the first network cell, wherein the tracking area identifier of the second network cell is different from a tracking area identifier of the first network cell. In some aspects of the disclosure, for example, the client device may receive the network access node list from a network entity (e.g., the network device 1010 illustrated in FIG. 10) or may be preconfigured with the network access node list. At block 1104, the client device may obtain, in the first network cell, a blacklist of known or suspected false network access nodes. At block 1106, the client device may detect one or more frequencies of the network access node of the third network cell. At block 1108, the client device may detect that a network access node of a third network cell is a false network access node based on at least the tracking area identifier of the second network cell, wherein at least a portion of the third network cell is included in at least one of the first network cell or the second network cell. For example, a portion of the third network cell may be considered to be included in a portion of the first network cell when at least some of the coverage area of the third network cell overlaps at least some of the coverage area of the first network cell. As another example, a portion of the third network cell may be considered to be included in a portion of a second network cell when at least some of the coverage area of the third network cell overlaps at least some of the coverage area of the second network cell. With reference to FIG. 8, for example, the coverage area of the Cell 99 (e.g., the third network cell) may be indicated with the region including striped shading, the coverage area of Cell 4 (e.g., the first network cell) may be indicated with a non-shaded region, and the coverage area of Cell 9 (e.g., the second network cell) may be indicated with a light gray shaded region.

With reference to FIG. 11B, at block 1110, the client device may refrain from connecting to the network access node of the third network cell and/or cease communication with the network access node of the third network cell in response to the detection. At block 1112, the client device may alert at least an application layer or an operating system of the client device about a potential threat in a network environment of the client device upon the detection. At block 1114, the client device may initiate communication with a different communication network. At block 1116, the client device may transmit a risk score associated with the third network cell after the detection.

In an aspect of the disclosure, the information further includes a security strength level value for a network access node of the second network cell, wherein the detection that the network access node of the third network cell is the false network access node is further based on the security strength level value. In an aspect of the disclosure, the information from the network access node list further indicates one or more frequency bands an operator may be using for the network access node of the second network cell, and wherein the detecting that the network access node of the third network cell is the false network access node is further based on the one or more frequency bands the operator may be using for the network access node of the second network cell. In an aspect of the disclosure, the security strength level value is based on one or more risk scores for the second network cell reported from one or more other client devices, and wherein the security strength level value indicates a measure of difficulty for the false network access node to imitate the network access node of the second network cell. In an aspect of the disclosure, the information from the network access node list includes a tracking area code flag, wherein when the tracking area code flag is enabled, the tracking area code flag indicates that the tracking area code of the first network cell may change in a periodic and/or predictable manner In an aspect of the disclosure, the information from the network access node list further indicates one or more time durations and corresponding one or more tracking area codes for the first network cell. In an aspect of the disclosure, the one or more time durations are portions of a repeatable period. In an aspect of the disclosure, the detecting that the network access node of the third network cell is the false network access node is further based on the network access node of the third network cell being included in the blacklist of known or suspected false network access nodes. In an aspect of the disclosure, the tracking area identifier of the second network cell is excluded from a tracking area identifier list of the client device in the first network cell, and wherein the information indicating the tracking area identifier of the second network cell in the network access node list notifies the client device to expect to perform a tracking area update procedure when entering a tracking area indicated in the tracking area identifier of the second network cell.

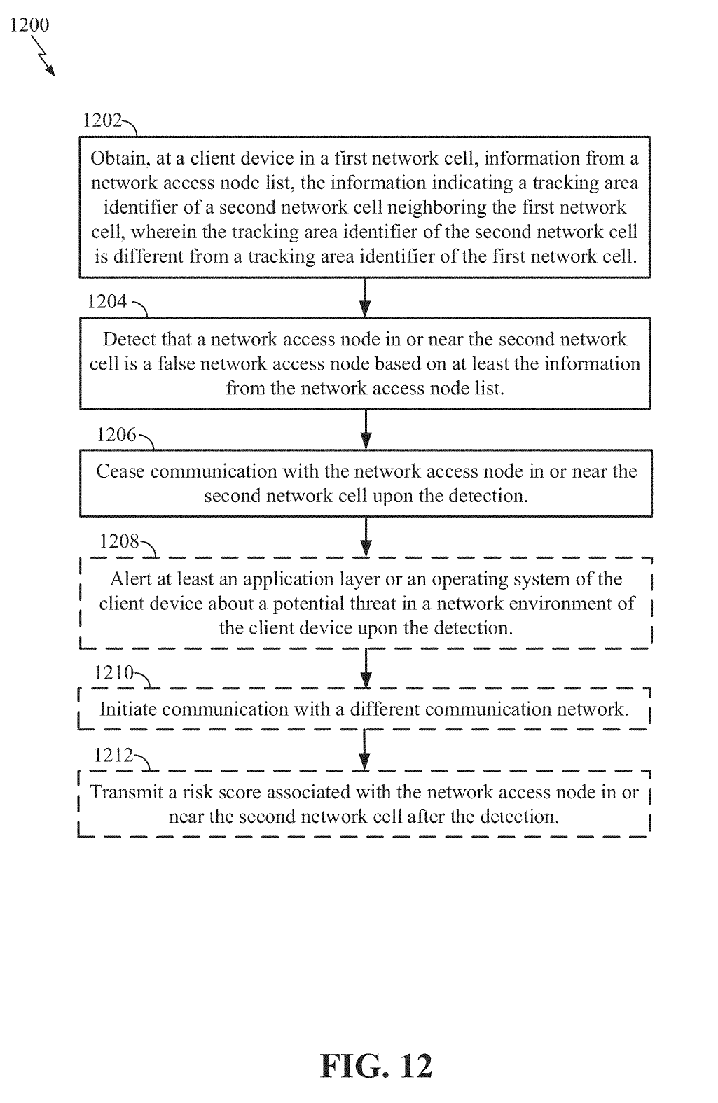

FIG. 12 is a flow chart illustrating an exemplary process 1200 in accordance with some aspects of the present disclosure. As described below, some or all illustrated features may be omitted in a particular implementation within the scope of the present disclosure, and some illustrated features may not be required for implementation of all embodiments. In some examples, the process 1200 may be carried out by the client device 300 illustrated in FIG. 3. In some examples, the process 1200 may be carried out by any suitable apparatus or means for carrying out the functions or algorithm described below. It should be understood that the blocks with dashed lines in FIG. 12 represent optional blocks.

At block 1202, the client device may obtain, in a first network cell, information from a network access node list, the information indicating a tracking area identifier of a second network cell neighboring the first network cell, wherein the tracking area identifier of the second network cell is different from a tracking area identifier of the first network cell. At block 1204, the client device may detect that a network access node in or near the second network cell is a false network access node based on at least the information from the network access node list. At block 1206, the client device may cease communication with the network access node in or near the second network cell upon the detection. At block 1208, the client device may alert at least an application layer or an operating system of the client device about a potential threat in a network environment of the client device upon the detection. At block 1210, the client device may initiate communication with a different communication network. At block 1212, the client device may transmit a risk score associated with the network access node in or near the second network cell after the detection.

FIG. 13 is a flow chart illustrating an exemplary process 1300 in accordance with some aspects of the present disclosure. As described below, some or all illustrated features may be omitted in a particular implementation within the scope of the present disclosure, and some illustrated features may not be required for implementation of all embodiments. In some examples, the process 1300 may be carried out by the client device 300 illustrated in FIG. 3. In some examples, the process 1300 may be carried out by any suitable apparatus or means for carrying out the functions or algorithm described below.

At block 1302, the client device may obtain, in a first geographical location, at least one portion of a network access node list associated with a second geographical location, wherein the second geographical location is an intended destination of the client device. In an aspect, the obtaining the at least one portion of the network access node list associated with the second geographical location may include requesting information for identifying the second geographical location from a user of the client device, identifying geographical coordinates of the second geographical location based on the requested information, and determining the network access node list corresponding to the geographical coordinates. In an aspect, the requested information includes at least a country, city, town, village, or a zip code. In an aspect, the obtaining the at least one portion of the network access node list associated with the second geographical location includes determining a plurality of possible destinations from the first geographical location, identifying geographical coordinates for each of the plurality of possible destinations, determining one or more network access node lists corresponding to the geographical coordinates, wherein the one or more network access node lists includes the network access node list associated with the second geographical location, and receiving the at least one portion of the network access node list associated with the second geographical location. In an aspect, the at least one portion of the network access node list exclusively includes tracking area identifier information when a number of the plurality of possible destinations exceeds a threshold. At block 1304, the client device may store the at least one portion of the network access node list in a memory of the client device. At block 1306, the client device may disable a transceiver of the client device after the at least one portion of the network access node list has been stored. At block 1308, the client device may enable the transceiver of the client device at the second geographical location. At block 1310, the client device may detect that a network access node observed in the second geographical location is a false network access node based on the at least one portion of the network access node list.

FIG. 14 is a flow chart illustrating an exemplary process 1400 in accordance with some aspects of the present disclosure. As described below, some or all illustrated features may be omitted in a particular implementation within the scope of the present disclosure, and some illustrated features may not be required for implementation of all embodiments. In some examples, the process 1400 may be carried out by the client device 300 illustrated in FIG. 3. In some examples, the process 1400 may be carried out by any suitable apparatus or means for carrying out the functions or algorithm described below.

At block 1402, the client device may obtain future availability information from a network access node list, the future availability information including at least an indication that a network access node operates intermittently, a periodic ON/OFF switching pattern of the network access node, aperiodic ON/OFF future time values listed as a vector of time values for the network access node, or one or more future time periods during which the network access node will be operating, wherein the availability information is based on information gathered from at least a public information system, a publicly available source, or a website. In an aspect, a location of the network access node is fixed, and the information gathered from at least a public information system, a publicly available source, or a website includes a venue and a time of a scheduled event. In such aspect, the location of the network access node is proximate to the venue of the scheduled event. In an aspect, the network access node is a femto network access node or a pico network access node. At block 1404, the client device may communicate with the network access node based on the availability information from the network access node list.

FIG. 15 is a flow chart illustrating an exemplary process 1500 in accordance with some aspects of the present disclosure. As described below, some or all illustrated features may be omitted in a particular implementation within the scope of the present disclosure, and some illustrated features may not be required for implementation of all embodiments. In some examples, the process 1500 may be carried out by the network device 400 illustrated in FIG. 4 and/or the network device 1010 illustrated in FIG. 10. In some examples, the process 1500 may be carried out by any suitable apparatus or means for carrying out the functions or algorithm described below. It should be understood that the blocks with dashed lines in FIG. 15 represent optional blocks.

At block 1502, the network device may obtain first availability information for at least one network access node from at least a public information system, a publicly available source, or a website, the first availability information including at least an indication that the at least one network access node operates intermittently, a periodic ON/OFF pattern of the at least one network access node, or one or more future time periods during which the at least one network access node will be operating. In an aspect, a location of the at least one network access node is fixed. In such aspect, the obtaining the availability information includes obtaining a venue and a time of a scheduled event from at least the public information system, the publicly available source, or the website, and determining that the location of the at least one network access node is proximate to the venue, wherein the availability information is based on at least the venue or the time of the scheduled event. At block 1504, the network device may store the first availability information in an entry in a network access node list, wherein the entry corresponds to the at least one network access node. At block 1506, the network device may transmit at least one portion of the network access node list to a client device, the at least one portion including the first availability information. At block 1508, the network device may discard second availability information stored in the entry in the network access node list when the second availability information corresponds to a time period that has already passed.

FIG. 16 is a flow chart illustrating an exemplary process 1600 in accordance with some aspects of the present disclosure. As described below, some or all illustrated features may be omitted in a particular implementation within the scope of the present disclosure, and some illustrated features may not be required for implementation of all embodiments. In some examples, the process 1600 may be carried out by the network device 400 illustrated in FIG. 4 and/or the network device 1010 illustrated in FIG. 10. In some examples, the process 1600 may be carried out by any suitable apparatus or means for carrying out the functions or algorithm described below. It should be understood that the blocks with dashed lines in FIG. 16 represent optional blocks.

At block 1602, the network device may obtain information from one or more client devices, wherein the information includes at least a notification that a mutual authentication procedure with a network access node has failed, a risk score indicating a probability that the network access node is a false network access node, one or more frequencies an operator has used for the network access node, or one or more tracking area codes assigned to the network access node at different time periods. At block 1604, the network device may determine that the network access node uses the one or more tracking area codes at the different time periods based on the information. In such aspect, the one or more values includes a tracking area code flag configured to indicate that a tracking area code of the network access node changes in a periodic and/or predictable manner At block 1606, the network device may determine one or more time durations and corresponding tracking area codes for the network access node based on the information. In such aspect, the one or more values includes the one or more time durations and the corresponding tracking area codes. At block 1608, the network device may store at least the information or one or more values based on the information in an entry of a network access node list, wherein the entry corresponds to the network access node. In some aspects of the disclosure, the information or the one or more values is stored when the one or more client devices from which the information is obtained has successfully performed the mutual authentication procedure with at least one network access node. At block 1610, the network device may transmit at least one portion of the network access node list to at least one client device. In some aspects of the disclosure, the one or more time durations are portions of a repeatable period. In some aspects of the disclosure, the at least one client device is one of the one or more client devices. In some aspects of the disclosure, the at least one client device is not one of the one or more client devices.

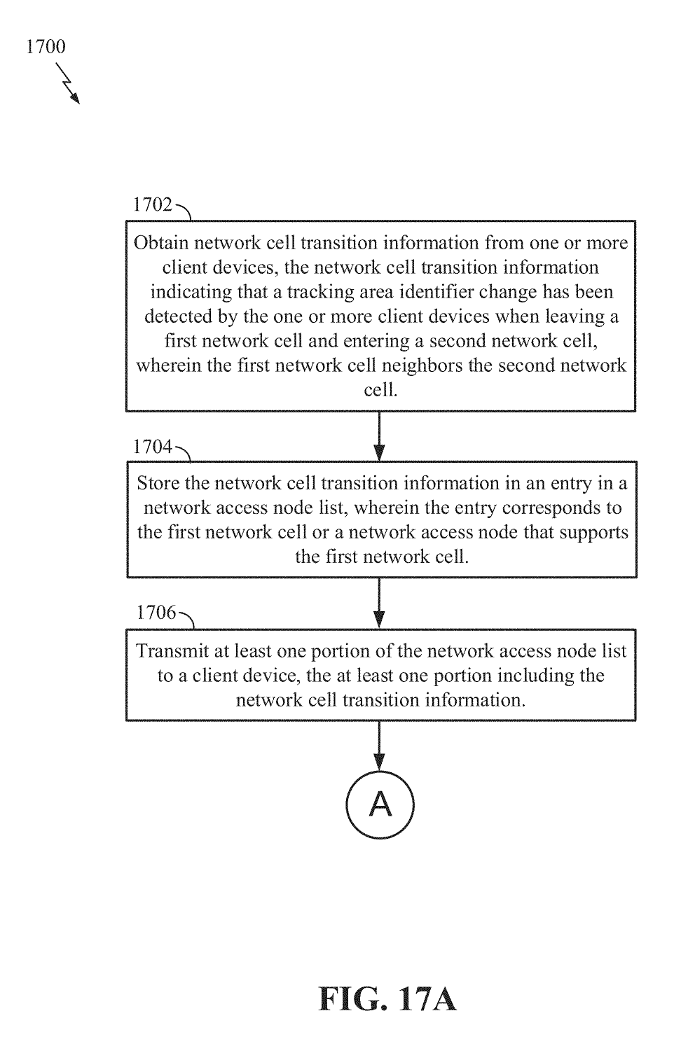

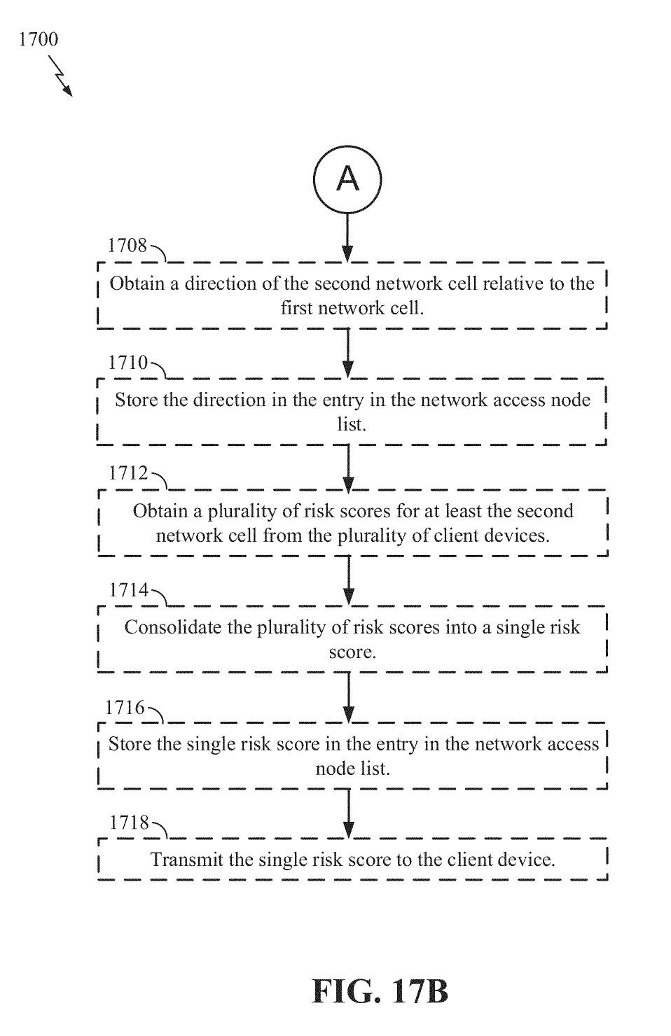

FIG. 17 (including FIGS. 17A and 17B) is a flow chart illustrating an exemplary process 1700 in accordance with some aspects of the present disclosure. As described below, some or all illustrated features may be omitted in a particular implementation within the scope of the present disclosure, and some illustrated features may not be required for implementation of all embodiments. In some examples, the process 1700 may be carried out by the network device 400 illustrated in FIG. 4 and/or the network device 1010 illustrated in FIG. 10. In some examples, the process 1700 may be carried out by any suitable apparatus or means for carrying out the functions or algorithm described below. It should be understood that the blocks with dashed lines in FIG. 17 represent optional blocks.

With reference to FIG. 17A, at block 1702, the network device may obtain network cell transition information from one or more client devices, the network cell transition information indicating that a tracking area identifier change has been detected by the one or more client devices when leaving a first network cell and entering a second network cell, wherein the first network cell neighbors the second network cell. In an aspect, the network cell transition information includes at least one tracking area identifier that is different from a tracking area identifier of the first network cell. At block 1704, the network device may store the network cell transition information in an entry in a network access node list, wherein the entry corresponds to the first network cell or a network access node that supports the first network cell. At block 1706, the network device may transmit at least one portion of the network access node list to a client device, the at least one portion including the network cell transition information. With reference to FIG. 17B, at block 1708, the network device may obtain a direction of the second network cell relative to the first network cell. At block 1710, the network device may store the direction in the entry in the network access node list. At block 1712, the network device may obtain a plurality of risk scores for at least the second network cell from the plurality of client devices. At block 1714, the network device may consolidate the plurality of risk scores into a single risk score. At block 1716, the network device may store the single risk score in the entry in the network access node list. At block 1718, the network device may transmit the single risk score to the client device.

In one configuration, the apparatus 300 includes means for obtaining, in a first network cell, information from a network access node list (also referred to as a geographical whitelist database of authentic network access nodes), the information indicating a tracking area identifier of a second network cell neighboring the first network cell, wherein the tracking area identifier of the second network cell is different from a tracking area identifier of the first network cell, means for detecting that a network access node of a third network cell is a false network access node based on at least the tracking area identifier of the second network cell, wherein at least a portion of the third network cell is included in at least one of the first network cell or the second network cell, means for detecting that a network access node in or near the second network cell is a false network access node based on at least the information from the network access node list, means for refraining from connecting to the network access node of the third network cell and/or ceasing communication with the network access node of the third network cell in response to the detection, means for ceasing communication with the network access node in or near the second network cell upon the detection, means for obtaining a blacklist of known or suspected false network access nodes, means for alerting at least an application layer or an operating system of the apparatus about a potential threat in a network environment of the apparatus upon the detection, means for initiating communication with a different communication network, means for transmitting a risk score associated with the network access node of the third network cell after the detection, means for transmitting a risk score associated with the network access node in or near the second network cell after the detection, means for obtaining, in a first geographical location, at least one portion of a network access node list associated with a second geographical location, wherein the second geographical location is an intended destination of the apparatus, means for storing the at least one portion of the network access node list in a memory of the apparatus, means for disabling a transceiver of the apparatus after the at least one portion of the network access node list has been stored, means for enabling the transceiver of the apparatus at the second geographical location, means for detecting that a network access node in the second geographical location is a false network access node based on the at least one portion of the network access node list, means for obtaining, future availability information from a network access node list, the future availability information including at least an indication that a network access node operates intermittently, a periodic ON/OFF switching pattern of the network access node, aperiodic ON/OFF future time values listed as a vector of time values for the network access node, or one or more future time periods during which the network access node will be operating, wherein the availability information is based on information gathered from at least a public information system, a publicly available source, or a website, and/or means for communicating with the network access node based on the availability information from the network access node list. In one aspect, the aforementioned means may be the processor 304 configured to perform the functions recited by the aforementioned means. In another aspect, the aforementioned means may be a circuit or any apparatus configured to perform the functions recited by the aforementioned means.

Of course, in the above examples, the circuitry included in the processor 304 is merely provided as an example, and other means for carrying out the described functions may be included within various aspects of the present disclosure, including but not limited to the instructions stored in the computer-readable storage medium 306, or any other suitable apparatus or means described in any one of the FIGS. 1 and/or 2, and utilizing, for example, the processes and/or algorithms described herein in relation to FIGS. 11-14.

In one configuration, the apparatus 400 includes means for obtaining first availability information for at least one network access node from at least a public information system, a publicly available source, or a website, the first availability information including at least an indication that the at least one network access node operates intermittently, a periodic ON/OFF pattern of the at least one network access node, or one or more future time periods during which the at least one network access node will be operating, means for storing the first availability information in an entry in a network access node list, wherein the entry corresponds to the at least one network access node, means for transmitting at least one portion of the network access node list to a client device, the at least one portion including the first availability information, means for discarding second availability information stored in the entry in the network access node list when the second availability information corresponds to a time period that has already passed, means for obtaining network cell transition information from one or more client devices, the network cell transition information indicating that a tracking area identifier change has been detected by the one or more client devices when leaving a first network cell and entering a second network cell, wherein the first network cell neighbors the second network cell, means for storing the network cell transition information in an entry in a network access node list, wherein the entry corresponds to the first network cell or a network access node that supports the first network cell, means for transmitting at least one portion of the network access node list to a client device, the at least one portion including the network cell transition information, means for obtaining a direction of the second network cell relative to the first network cell, means for storing the direction in the entry in the network access node list, means for obtaining a plurality of risk scores for at least the second network cell from the plurality of client devices, means for consolidating the plurality of risk scores into a single risk score, means for storing the single risk score in the entry in the network access node list, means for transmitting the single risk score to the client device, means for obtaining information from one or more client devices, wherein the information includes at least a notification that a mutual authentication procedure with a network access node has failed, a risk score indicating a probability that the network access node is a false network access node, one or more frequencies an operator has used for the network access node, or one or more tracking area codes assigned to the network access node at different time periods, means for storing at least the information or one or more values based on the information in an entry of a network access node list, wherein the entry corresponds to the network access node, means for determining that the network access node uses the one or more tracking area codes at the different time periods based on the information, means for determining one or more time durations and corresponding tracking area codes for the network access node based on the information. In one aspect, the aforementioned means may be the processor 404 configured to perform the functions recited by the aforementioned means. In another aspect, the aforementioned means may be a circuit or any apparatus configured to perform the functions recited by the aforementioned means.

Of course, in the above examples, the circuitry included in the processor 404 is merely provided as an example, and other means for carrying out the described functions may be included within various aspects of the present disclosure, including but not limited to the instructions stored in the computer-readable storage medium 406, or any other suitable apparatus or means described in any one of the FIGS. 1 and/or 2, and utilizing, for example, the processes and/or algorithms described herein in relation to FIGS. 15-17.

Several aspects of a wireless communication network have been presented with reference to an exemplary implementation. As those skilled in the art will readily appreciate, various aspects described throughout this disclosure may be extended to other telecommunication systems, network architectures and communication standards.

By way of example, various aspects may be implemented within other systems defined by 3GPP, such as Long-Term Evolution (LTE), the Evolved Packet System (EPS), the Universal Mobile Telecommunication System (UMTS), and/or the GSM. Various aspects may also be extended to systems defined by the 3rd Generation Partnership Project 2 (3GPP2), such as CDMA2000 and/or Evolution-Data Optimized (EV-DO). Other examples may be implemented within systems employing IEEE 802.11 (Wi-Fi), IEEE 802.16 (WiMAX), IEEE 802.20, Ultra-Wideband (UWB), Bluetooth, and/or other suitable systems. The actual telecommunication standard, network architecture, and/or communication standard employed will depend on the specific application and the overall design constraints imposed on the system.

Within the present disclosure, the word “exemplary” is used to mean “serving as an example, instance, or illustration.” Any implementation or aspect described herein as “exemplary” is not necessarily to be construed as preferred or advantageous over other aspects of the disclosure. Likewise, the term “aspects” does not require that all aspects of the disclosure include the discussed feature, advantage or mode of operation. The term “coupled” is used herein to refer to the direct or indirect coupling between two objects. For example, if object A physically touches object B, and object B touches object C, then objects A and C may still be considered coupled to one another—even if they do not directly physically touch each other. For instance, a first object may be coupled to a second object even though the first object is never directly physically in contact with the second object. The terms “circuit” and “circuitry” are used broadly, and intended to include both hardware implementations of electrical devices and conductors that, when connected and configured, enable the performance of the functions described in the present disclosure, without limitation as to the type of electronic circuits, as well as software implementations of information and instructions that, when executed by a processor, enable the performance of the functions described in the present disclosure. As used herein, the term “obtaining” may include one or more actions including, but not limited to, receiving, generating, determining, or any combination thereof.

One or more of the components, steps, features and/or functions illustrated in FIGS. 1-17 may be rearranged and/or combined into a single component, step, feature or function or embodied in several components, steps, or functions. Additional elements, components, steps, and/or functions may also be added without departing from novel features disclosed herein. The apparatus, devices, and/or components illustrated in FIGS. 1-17 may be configured to perform one or more of the methods, features, or steps described herein. The novel algorithms described herein may also be efficiently implemented in software and/or embedded in hardware.

It is to be understood that the specific order or hierarchy of steps in the methods disclosed is an illustration of exemplary processes. Based upon design preferences, it is understood that the specific order or hierarchy of steps in the methods may be rearranged. The accompanying method claims present elements of the various steps in a sample order, and are not meant to be limited to the specific order or hierarchy presented unless specifically recited therein.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b and c. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112(f) unless the element is expressly recited using the phrase “means for” or, in the case of a method claim, the element is recited using the phrase “step for.”

What is claimed is:

1. A method, comprising:
obtaining, at a client device in a first network cell, information from a network access node list, the information indicating a tracking area identifier of a second network cell neighboring the first network cell, wherein the tracking area identifier of the second network cell is different from a tracking area identifier of the first network cell;
detecting that a network access node of a third network cell is a false network access node based on at least the tracking area identifier of the second network cell, wherein at least a portion of the third network cell is included in at least one of the first network cell or the second network cell; and
refraining from connecting to the network access node of the third network cell and/or ceasing communication with the network access node of the third network cell in response to the detection.

2. The method of claim 1, wherein the information further includes a security strength level value for a network access node of the second network cell, wherein detecting that the network access node of the third network cell is the false network access node is further based on the security strength level value.

3. The method of claim 2, wherein the security strength level value is based on one or more risk scores for the second network cell reported from one or more other client devices, and wherein the security strength level value indicates a measure of difficulty for the false network access node to imitate the network access node of the second network cell.

4. The method of claim 1, further comprising:
alerting at least an application layer or an operating system of the client device about a potential threat in a network environment of the client device upon the detection.

5. The method of claim 1, further comprising:
initiating communication with a different communication network.

6. The method of claim 1, further comprising:
transmitting a risk score associated with the third network cell after the detection.

7. The method of claim 1, wherein the information from the network access node list includes a tracking area code flag, wherein when the tracking area code flag is enabled, the tracking area code flag indicates that the tracking area code of the first network cell may change in a periodic and/or predictable manner

8. The method of claim 7, wherein the information from the network access node list further indicates one or more time durations and corresponding one or more tracking area codes for the first network cell.

9. The method of claim 1, wherein the tracking area identifier of the second network cell is excluded from a tracking area identifier list of the client device in the first network cell, and wherein the information indicating the tracking area identifier of the second network cell in the network access node list notifies the client device to expect to perform a tracking area update procedure when entering a tracking area indicated in the tracking area identifier of the second network cell.

10. The method of claim 1, further comprising:
obtaining a blacklist of known or suspected false network access nodes;
wherein the detecting that the network access node of the third network cell is the false network access node is further based on the network access node of the third network cell being included in the blacklist of known or suspected false network access nodes.

11. The method of claim 1, further comprising:
detecting one or more frequencies of the network access node of the third network cell,
wherein the information from the network access node list further indicates one or more frequency bands an operator may be using for the network access node of the second network cell, and wherein the detecting that the network access node of the third network cell is the false network access node is further based on the one or more frequency bands the operator may be using for the network access node of the second network cell.

12. A method comprising:
obtaining, at a client device in a first geographical location, at least one portion of a network access node list associated with a second geographical location, wherein the second geographical location is an intended destination of the client device;
storing the at least one portion of the network access node list in a memory of the client device;
disabling a transceiver of the client device after the at least one portion of the network access node list has been stored;
enabling the transceiver of the client device at the second geographical location; and
detecting that a network access node observed in the second geographical location is a false network access node based on the at least one portion of the network access node list.

13. The method of claim 12, wherein the obtaining the at least one portion of the network access node list associated with the second geographical location includes:
requesting information for identifying the second geographical location from a user of the client device;
identifying geographical coordinates of the second geographical location based on the requested information; and
determining the network access node list corresponding to the geographical coordinates.

14. The method of claim 13, wherein the requested information includes at least a country, city, town, village, or a zip code.

15. The method of claim 12, wherein the obtaining the at least one portion of the network access node list associated with the second geographical location includes:
determining a plurality of possible destinations from the first geographical location;
identifying geographical coordinates for each of the plurality of possible destinations;
determining one or more network access node lists corresponding to the geographical coordinates, wherein the one or more network access node lists includes the network access node list associated with the second geographical location; and
receiving the at least one portion of the network access node list associated with the second geographical location.

16. The method of claim 12, wherein the at least one portion of the network access node list exclusively includes tracking area identifier information when a number of the plurality of possible destinations exceeds a threshold.

17. An apparatus comprising:
a processing circuit configured to:
obtain, at the apparatus in a first network cell, information from a network access node list, the information indicating a tracking area identifier of a second network cell neighboring the first network cell, wherein the tracking area identifier of the second network cell is different from a tracking area identifier of the first network cell;
obtain, at the apparatus in the first network cell, a new tracking area identifier list that includes the tracking area identifier of the second network cell;
detect that a network access node of a third network cell is a false network access node based on at least the new tracking area identifier list, wherein at least a portion of the third network cell is included in at least one of the first network cell or the second network cell; and
refrain from connecting to the network access node of the third network cell and/or cease communication with the network access node of the third network cell in response to the detection.

18. The apparatus of claim 17, wherein the information further includes a security strength level value for a network access node of the second network cell, wherein detecting that the network access node of the third network cell is the false network access node is further based on the security strength level value.

19. The apparatus of claim 18, wherein the security strength level value is based on one or more risk scores for the second network cell reported from one or more other apparatus, and wherein the security strength level value indicates a measure of difficulty for the false network access node to imitate the network access node of the second network cell.

20. The apparatus of claim 17, wherein the processing circuit is further configured to:
alert at least an application layer or an operating system of the apparatus about a potential threat in a network environment of the apparatus upon the detection.

21. The apparatus of claim 17, wherein the processing circuit is further configured to:
initiate communication with a different communication network.

22. The apparatus of claim 17, wherein the processing circuit is further configured to:
transmit a risk score associated with the third network cell after the detection.

23. The apparatus of claim 17, wherein the information from the network access node list includes a tracking area code flag, wherein when the tracking area code flag is enabled, the tracking area code flag indicates that the tracking area code of the first network cell may change in a periodic and/or predictable manner

24. The apparatus of claim 23, wherein the information from the network access node list further indicates one or more time durations and corresponding one or more tracking area codes for the first network cell.

25. The apparatus of claim 24, wherein the one or more time durations are portions of a repeatable period.

26. The apparatus of claim 17, wherein the processing circuit is further configured to:
detect one or more frequencies of the network access node of the third network cell,
wherein the information from the network access node list further indicates one or more frequency bands an operator may be using for the network access node of the second network cell, and wherein the detecting that the network access node of the third network cell is the false network access node is further based on the one or more frequency bands the operator may be using for the network access node of the second network cell.

27. An apparatus comprising:
a processing circuit configured to:
obtain, at the apparatus in a first geographical location, at least one portion of a network access node list associated with a second geographical location, wherein the second geographical location is an intended destination of the apparatus;
store the at least one portion of the network access node list in a memory of the apparatus;
disable a transceiver of the apparatus after the at least one portion of the network access node list has been stored;
enable the transceiver of the apparatus at the second geographical location; and
detect that a network access node observed in the second geographical location is a false network access node based on the at least one portion of the network access node list.

28. The apparatus of claim 27, wherein the processing circuit configured to obtain the at least one portion of the network access node list associated with the second geographical location is further configured to:
request information for identifying the second geographical location from a user of the apparatus;
identify geographical coordinates of the second geographical location based on the requested information; and
determine the network access node list corresponding to the geographical coordinates.

29. The apparatus of claim 28, wherein the requested information includes at least a country, city, town, village, or a zip code.

30. The apparatus of claim 27, wherein the processing circuit configured to obtain the at least one portion of the network access node list associated with the second geographical location is further configured to:
determine a plurality of possible destinations from the first geographical location;
identify geographical coordinates for each of the plurality of possible destinations;
determine one or more network access node lists corresponding to the geographical coordinates, wherein the one or more network access node lists includes the network access node list associated with the second geographical location; and
receive the at least one portion of the network access node list associated with the second geographical location.
